(19) United States
(12) Patent Application Publication
(10) Pub. No.: US 2026/0203997 A1
(43) Pub. Date: Jul. 16, 2026

(54) ELECTRONIC DEVICE AND METHOD FOR PROVIDING 3D IMAGE INCLUDING GRAPHIC OBJECT

(71) Applicant: Samsung Electronics Co., Ltd., Suwon-si (KR)

(72) Inventors: Hyejee CHOI, Suwon-si (KR); Hoon HAN, Suwon-si Gyeonggi-do (KR); Changmo YANG, Suwon-si (KR); Jaewan CHOI, Suwon-si (KR)

(21) Appl. No.: 19/438,956

(22) Filed: Jan. 2, 2026

Related U.S. Application Data
(63) Continuation of application No. PCT/KR2024/008774, filed on Jun. 25, 2024.

(30) Foreign Application Priority Data
Jul. 3, 2023 (KR) 10-2023-0085614
Sep. 14, 2023 (KR) 10-2023-0122380

(51) Int. Cl. G06T 15/20; G02B 30/27

(52) U.S. Cl. CPC G06T 15/20; G02B 30/27

(57) ABSTRACT

An electronic device may include: a display; a memory; and at least one processor operatively connected to the display and the memory. The memory may store instructions which are executable by the at least one processor individually and/or collectively and cause, when executed, the electronic device to: when a 3D image to be output via the display of the electronic device includes a first graphic object and a second graphic object that is disposed to at least partially overlap the first graphic object, determine z-axis direction position indicating positions in a z-axis direction substantially perpendicular to the display at which the first graphic object and the second graphic object to be placed on the 3D image, based on attributes of the first graphic object and the second graphic object; and render the 3D image, including the first graphic object and the second graphic object, wherein the first graphic object and the second graphic object are recognizable at the determined z-axis direction positions.

### CROSS-REFERENCE TO RELATED APPLICATIONS

This application is a continuation application of International Application No. PCT/KR2024/008774 designating the United States, filed on Jun. 25, 2024, in the Korean Intellectual Property Receiving Office and claiming priority to Korean Patent Application No. 10-2023-0085614, filed on Jul. 3, 2023, and Korean Patent Application No. 10-2023-0122380, filed on Sep. 14, 2023, the disclosures of which are all hereby incorporated by reference herein in their entireties.

### TECHNICAL FIELD

Various example embodiments may relate to an electronic device and/or, for example, to a method and/or device/system for rendering a 3D image containing various types of graphical objects and presenting it through the display.

### BACKGROUND

A portable electronic device such as a smartphone (e.g., “electronic device”) can provide the user with diverse user experiences through various applications and/or multimedia content. The electronic device may include a display for providing applications and multimedia content. The electronic device may provide graphical objects such as application icons and widgets through the display, and may provide various information and/or user interactions through the graphical objects.

To provide users with more realistic environments, three-dimensional (3D) displays are being introduced. 3D displays may be categorized into glasses-based and glasses-free types. Electronic devices such as smartphones are being developed as glasses-free 3D displays due to their inherent characteristics.

### SUMMARY

When providing graphical objects on a 2D display, graphical objects may be arranged on the plane of the display and their arrangement may be changed according to user input. Since the electronic device has a limited display size, graphical objects may be implemented to be stackable for efficient arrangement.

Unlike the case of a 2D display, an electronic device with a 3D display may place and move graphical objects in a vertical direction (or, in z-axis direction) of the display. Hence, unlike a 2D display that arranges graphical objects along the x-axis and y-axis parallel to the plane of the display, the 3D display may utilize the spatial z-axis to provide a variety of widgets in various forms.

An electronic device according to certain example embodiments may include a display, a memory, and at least one processor, comprising processing circuitry, operably connected, directly or indirectly, to the display and/or the memory.

According to an example embodiment, the processor(s) may render a 2D image or a 3D image that includes a first image recognizable to the user's left eye and a second image including a right-eye image recognizable to the user's right eye, and output the same through the display.

According to an example embodiment, the memory may store instructions that are executable by at least one processor individually and/or collectively and, when executed, may cause the electronic device to: render a 2D image or a 3D image that includes a first image recognizable to the user's left eye and a second image including a right-eye image recognizable to the user's right eye to output the same through the display; determine, if the 3D image to be output through the display includes a first graphical object and a second graphical object placed to overlap at least partially with the first graphical object, the positions in the z-axis direction being perpendicular to the display at which the first graphical object and the second graphical object are to be placed on the 3D image on the basis of the attributes of the first graphical object and the second graphical object; and render the 3D image including the first graphical object and the second graphical object so that the first graphical object and the second graphical object can be recognized respectively at the determined positions in the z-axis direction.

According to various example embodiments, the electronic device potentially including a 3D display can arrange graphical objects in accordance with their attributes to thereby provide a 3D image including graphical objects in a form suitable for user experience.

### BRIEF DESCRIPTION OF DRAWINGS

FIG. 1 is a block diagram of an electronic device in a network environment according to various example embodiments.

FIGS. 2A and 2B illustrate the structure of a 3D display according to an example embodiment.

FIGS. 3A, 3B and 3C illustrate a method for an electronic device to provide a three-dimensional effect by using two images according to an example embodiment.

FIG. 4 is a block diagram of an electronic device according to various example embodiments.

FIG. 5 illustrates an example of 3D planes formed in the z-axis direction from the display according to an example embodiment.

FIGS. 6A, 6B and 6C illustrate an example of 3D planes formed in the z-axis direction from the display according to an example embodiment.

FIG. 7 illustrates graphical objects arranged on 3D planes according to an example embodiment.

FIGS. 8A, 8B, 8C, 8D, 8E, 8F, 8G, 8H, 8I, 8J, 8K, 8L, 8M, 8N, 8O, 8P, 8Q, 8R, 8S and 8T illustrate a method of stacking and arranging graphical objects in accordance with their attributes according to an example embodiment(s).

FIGS. 9A, 9B and 9C illustrate a method of stacking and arranging graphical objects in accordance with their attributes according to an example embodiment.

FIG. 10 illustrates a method for determining the size of a graphical object according to an example embodiment.

FIGS. 11A and 11B illustrate a method of stacking and arranging graphical objects based on the characteristics of user interaction with each graphical object according to an example embodiment.

FIGS. 12A, 12B and 12C illustrate a method of stacking and arranging graphical objects based on the characteristics of user interaction with each graphical object according to an example embodiment.

FIG. 13 is a flowchart of a method for arranging graphical objects based on the size of each graphical object and the characteristics of user interaction according to an example embodiment.

FIGS. 14A, 14B and 14C illustrate a method for editing the position of a graphical object based on user input according to an example embodiment.

FIGS. 15A, 15B and 15C illustrate a method for editing the position of a graphical object based on user input according to an example embodiment.

FIGS. 16A, 16B and 16C illustrate a method for creating a graphical object in 2D or 3D according to an example embodiment.

FIGS. 17A and 17B illustrate a method for setting the shape of a graphical object depending on the position where the graphical object is arranged according to an example embodiment.

FIGS. 18A, 18B and 18C illustrate a method for transforming a graphical object based on the user's gaze direction according to an example embodiment.

FIGS. 19A, 19B and 19C illustrate a method for transforming a graphical object based on the user's gaze direction according to an example embodiment.

FIGS. 20A and 20B illustrate a method for changing the position of a graphical object based on user input according to an example embodiment.

FIG. 21 illustrates information provided on each face of a 3D graphical object according to an example embodiment.

FIGS. 22A, 22B and 22C illustrate information presented by a graphical object based on the tilted angle of the electronic device according to an example embodiment.

FIGS. 23A, 23B and 23C illustrate a method for changing the form of information included in graphical objects when stacking the graphical objects according to an example embodiment.

FIG. 24 is a flowchart of a method for providing a 3D image including graphical objects in the electronic device according to an example embodiment.

### DETAILED DESCRIPTION

Hereinafter, embodiments of the disclosure will be described in detail with reference to the drawings so that those skilled in the art can easily carry out the disclosure. However, the disclosure may be implemented in various different forms and is not limited to those embodiments described herein. In the description of the drawings, the same or similar reference symbols may be used for identical or similar components. Additionally, in the drawings and related descriptions, descriptions of well-known functions and configurations may be omitted for clarity and brevity.

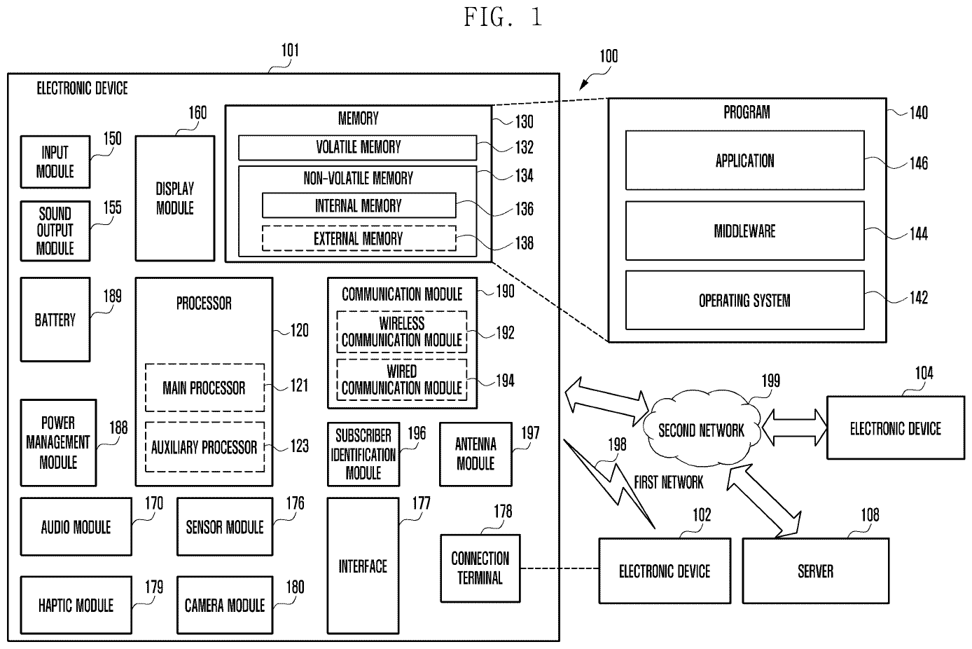

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In the following description, the direction perpendicular to the display (or display panel) of the electronic device may be referred to as the z-axis direction, the horizontal direction of the display perpendicular to the z-axis may be referred to as the x-axis direction, and the vertical direction thereof may be referred to as the y-axis direction.

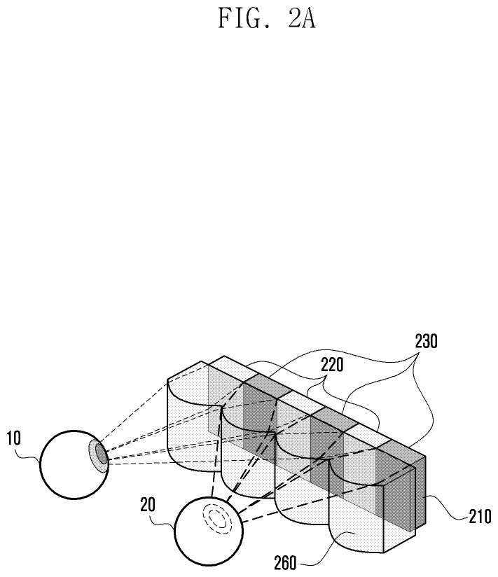

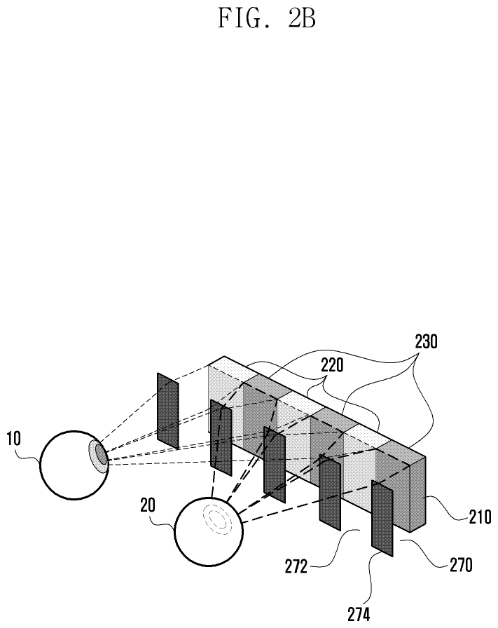

FIGS. 2A and 2B illustrate the structure of a 3D display according to an embodiment.

According to an embodiment, the electronic device (e.g., electronic device 101 in FIG. 1) may include a display (e.g., display module 160 in FIG. 1) that outputs various images. The image output from the display of the electronic device may be a 3 dimensional (3D) image that provides the user with a three-dimensional effect.

3D displays include a glasses-based scheme that allows the user to feel a three-dimensional effect when wearing glasses, and a glasses-free scheme that allows the user to feel a three-dimensional effect based on a structure arranged on the front of the display panel 210 without wearing glasses.

According to an embodiment, the electronic device can implement a glasses-free 3D display. The electronic device may utilize binocular parallax to generate a left-eye image (or first image) that can be recognized by the user's left eye 10 and a right-eye image (or second image) that can be recognized by the user's right eye 20, and simultaneously display the left-eye image and the right-eye image through designated pixels of the display panel 210.

According to an embodiment, the electronic device may include an optical structure that is disposed in front of the display panel 210 (or, in +z direction from the display panel 210) in a manner that the left-eye image output from the display panel 210 is substantially recognized by the user's left eye 10 and not recognized by the user's right eye 20, and the right-eye image is substantially recognized by the user's right eye 20 and not recognized by the user's left eye 10. For example, the electronic device may include a lenticular lens structure 260 in FIG. 2A or a parallax barrier structure 270 in FIG. 2B that allows the left-eye image and the right-eye image to be recognized respectively by the left eye 10 and the right eye 20.

With reference to FIG. 2A, a film (or glass) including a plurality of lenticular lenses 260 may be disposed on the front surface of the display panel 210 of the electronic device. According to an embodiment, each of the plural lenticular lenses 260 included in the film may cover a pixel column or group including multiple pixel columns. On the display panel 210, the left-eye image may be displayed on odd-numbered pixel columns (or groups) 220, and the right-eye image may be displayed on even-numbered pixel columns (or groups) 230.

According to an embodiment, those lenticular lenses covering the pixel columns 220 displaying the left-eye image may refract light corresponding to the output image in a direction corresponding to the position of the user's left eye 10, and those lenticular lenses covering the pixel columns 230 displaying the right-eye image may refract light corresponding to the output image in a direction corresponding to the position of the user's right eye 20. Here, the direction corresponding to the position of the left eye 10 and the direction corresponding to the position of the right eye 20 may be the direction from each pixel column toward the positions of the user's left eye 10 and right eye 20 when the user views the display from a frontal perspective at a preset distance from the display. According to this structure, even if the left-eye image and the right-eye image are output simultaneously on the display panel 210, only the left-eye image can be recognized through the user's left eye 10, and only the right-eye image can be recognized through the user's right eye 20.

With reference to FIG. 2B, a parallax barrier 270 may be disposed on the front surface of the display panel 210 of the electronic device. According to an embodiment, the parallax barrier 270 may include blocking bars (or black bars) 274 that block light output from the display panel 210 and slits 272 that allow light to pass through, which are arranged in an alternating manner. The horizontal width of the blocking bar 274 and the slit 272 may correspond to the horizontal width of pixel columns or groups including multiple pixel columns that alternately output the left-eye and right-eye images. As the blocking bars 274 and slits 272 are arranged in an alternating manner in the parallax barrier 270, the left-eye image output from the odd-numbered pixel columns (or groups) 220 may pass through the slits 272 to be recognized by the user's left eye 10, and the right-eye image output from the even-numbered pixel columns (or groups) 230 may be recognized by the user's right eye 20. In addition, the left-eye image may be blocked by the blocking bar 274 in the direction toward the user's right eye 20 not to be substantially recognized by the user's right eye 20, and the right-eye image may be blocked by the blocking bar 274 in the direction toward the user's left eye 10 not to be substantially recognized by the user's left eye 10.

In the disclosure, an example in which the electronic device implements a 3D screen by using a lenticular lens structure 260 in FIG. 2A or a parallax barrier structure 270 in FIG. 2B is described. However, the disclosure is not limited thereto, and the electronic device may include a glasses-free 3D display of another type.

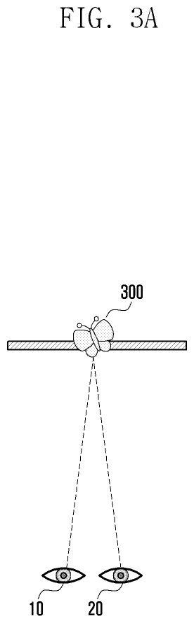

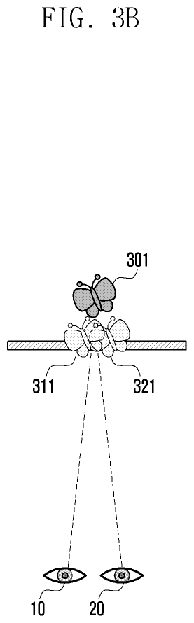

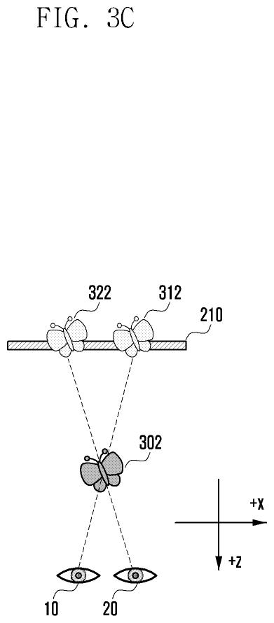

FIGS. 3A, 3B and 3C illustrate a method for the electronic device to provide a three-dimensional effect by using two images according to an embodiment.

According to an embodiment, the electronic device may provide a 3D image that produces a three-dimensional effect to the user by using a 3D display, such as the lenticular lens structure 260 in FIG. 2A or the parallax barrier structure 270 in FIG. 2B. For example, the electronic device may generate a left-eye image and a right-eye image and display the left-eye image and the right-eye image in an alternating manner through specified pixel columns (e.g., odd-numbered columns and even-numbered columns) of the display panel 210, so that the left-eye image can be recognized by the user's left eye 10 and the right-eye image can be recognized by the user's right eye 20.

With reference to FIG. 3A, when the graphical object of a left-eye image and the graphical object of a right-eye image are output through adjacent pixels on the display panel 210, the graphical object 300 of a 3D image recognized by the user as the graphical object of a left-eye image and the graphical object of a right-eye image are output may be recognized at the position of the display panel 210 with respect to the z-axis direction from the user's gaze.

With reference to FIG. 3B, when the graphical object 311 of a left-eye image is positioned to the left (or-x direction) and the graphical object 321 of a right-eye image is positioned to the right (or +x direction) with respect to the x-axis, the graphical object 301 of a 3D image may be recognized at a position farther than the display panel 210 with respect to the z-axis from the user's gaze. If the distance between the graphical object 311 of a left-eye image and the graphical object 321 of a right-eye image is formed to be greater than that in the example of FIG. 3B, the graphical object 301 of a 3D image will be recognized at a farther position with respect to the z-axis direction from the user's gaze.

With reference to FIG. 3C, when the graphical object 312 of a left-eye image is positioned to the right (or +x direction) and the graphical object 322 of a right-eye image is positioned to the left with respect to the x-axis direction, the graphical object 302 of a 3D image may be recognized at a position closer than the display panel 210 with respect to the z-axis direction from the user's gaze. If the distance between the graphical object 312 of a left-eye image and the graphical object 322 of a right-eye image is formed to be greater than that in the example of FIG. 3C, the graphical object 302 of a 3D image will be recognized at a closer position with respect to the z-axis direction from the user's gaze.

According to an embodiment, the electronic device may control the depth perception of a 3D image perceived by the user by adjusting the relative positions and/or distances between the left-eye image and the right-eye image. For example, to provide a 3D effect for a specific graphical object, the electronic device may render a left-eye image and right-eye image including graphical objects corresponding to the graphical object of a 3D image, and determine the position of each graphical object on the left-eye image and the right-eye image based on the determined z-axis direction position of the graphical object.

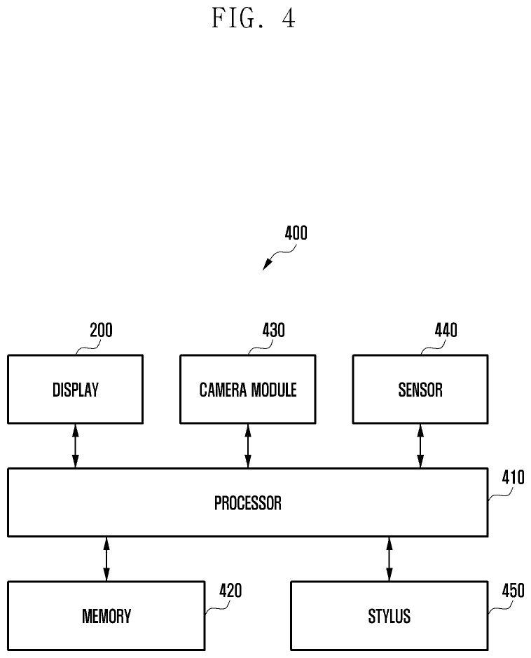

FIG. 4 is a block diagram of an electronic device according to various embodiments.

With reference to FIG. 4, the electronic device 400 according to an embodiment may include a display 200, a camera module 430, a sensor 440, a stylus 450, a processor 410, and a memory 420. Even if some of the illustrated components are omitted or replaced, various embodiments of the disclosure can be implemented. At least some of the illustrated components may be operably, electrically, and/or functionally connected, directly or indirectly, to one another. The electronic device 400 may include at least some of the components and/or functions of the electronic device 101 of FIG. 1.

According to an embodiment, some of the components of the electronic device 400 (e.g., sensor 440, processor 410, memory 420) may be disposed inside the housing of the electronic device 400, some other components (e.g., display 200, camera module 430) may have at least a portion thereof exposed to the outside of the housing, and the remaining components (e.g., stylus 450) may be configured to be detachably inserted into the housing of the electronic device 400.

According to an embodiment, the display 200 may output various images provided by the processor 410. For example, the display 200 may be implemented with, but not limited to, a liquid crystal display (LCD), a light-emitting diode (LED) display, or an organic light-emitting diode (OLED) display. The display 200 may be composed of a touchscreen that detects a touch and/or proximity (or hovering) input using a user's body part (e.g., finger) or the stylus 450. The display 200 may include at least some of the configurations and/or functions of the display module 160 in FIG. 1.

According to an embodiment, the display 200 may be implemented as a 3D display that provides a 3D image to the user. For example, the display 200 may include a structure such as a lenticular lens (e.g., lenticular lens 260 in FIG. 2A) or a parallax barrier (e.g., parallax barrier 270 in FIG. 2B) disposed on the front surface of the display panel including a plurality of pixels. The structure of the display 200 for implementing a 3D effect has been described with reference to FIGS. 2A and 2B.

According to an embodiment, the processor 410 may render a left-eye image recognizable by the user's left eye and a right-eye image recognizable by the user's right eye, and display them alternately on odd-numbered pixel columns (or groups including pixel columns) and even-numbered pixel columns (or groups including pixel columns) of the display 200. The processor 410 may adjust the relative positions and/or distance between the left-eye image and right-eye image to thereby control the z-axis position and depth perception of the 3D image perceived by the user. The image rendering method of the processor 410 for implementing a 3D effect has been described with reference to FIGS. 3A to 3C. In the following description, the left-eye image may be referred to as a first image, and the right-eye image may be referred to as a second image.

According to an embodiment, the camera module 430 may capture an image of a nearby subject, convert the image information into digital data, and provide it to the processor 410. The electronic device 400 may include at least one camera module 430 on the front side of the housing, where the display 200 is included, and/or on the rear side, which is opposite the front side. According to an embodiment, the camera module 430 may include a lens assembly including at least one lens that collects light emitted from the external environment (or subject), an image sensor (e.g., charged coupled device (CCD) sensor, complementary metal oxide semiconductor (CMOS) sensor) that converts the light collected through the lens assembly into an electrical signal to generate image data, and an image signal processor that performs various processing on the image data obtained from the image sensor. At least some of the aforementioned components of the camera module 430 may be omitted or replaced with other components. The camera module 430 may provide captured images of the external environment to the processor 410 in real time via an interface (e.g., mobile industry processor interface). The camera module 430, comprising a camera, may include at least some of the configurations and/or functions of the camera module 180 in FIG. 1.

According to an embodiment, the processor 410 may track the position of the user's gaze based on images obtained from the camera module 430 (e.g., front camera). For example, the processor 410 may analyze an image obtained in real time from the camera module 430 to extract the user's eye region, and monitor the movement of the pupil to track the user's gaze position. “Based on” as used herein covers based at least on.

According to an embodiment, the electronic device 400 may include at least one sensor 440. For example, the electronic device 400 may further include various types of sensors, such as an acceleration sensor, a gesture sensor, a gyro sensor, a pressure sensor, a magnetic sensor, a grip sensor, a proximity sensor, a color sensor, an infrared (IR) sensor, a biometric sensor, a temperature sensor, a humidity sensor, or an illuminance sensor. The electronic device 400 may include at least some of the configurations and/or functions of the sensor module 176, comprising at least one sensor, in FIG. 1.

According to an embodiment, the electronic device 400 may sense the inclination (or angle formed with the ground) of the electronic device 400 by using at least one sensor 440 (e.g., acceleration sensor, gyro sensor). For example, the acceleration sensor may sense acceleration in the three-axis (x-axis, y-axis, z-axis) direction, the gyro sensor may sense angular velocity, and the processor 410 may identify the inclination of the electronic device 400 based on acceleration data obtained from the acceleration sensor and angular velocity data obtained from the gyro sensor.

According to an embodiment, the electronic device 400 may include a stylus 450 that the user may use for input on the display 200. For example, the user may use the stylus 450 to enter a touch input on the display 200, and enter a hovering input (or proximity input) while being spaced apart from the display 200. The stylus 450 may have an overall thin and long shape, and the electronic device 400 may include a groove into which the stylus 450 may be inserted. The stylus 450 may include at least one button, and when a user input on the button is detected, a signal corresponding to the user input may be transmitted to the electronic device 400 via short-range wireless communication.

According to an embodiment, the memory 420 may include a volatile memory and a non-volatile memory to temporarily or permanently store various data. The memory 420 may include at least some of the configurations and/or functions of the memory 130 in FIG. 1, and may store the programs 140 in FIG. 1. The memory 420 may store various instructions that can be executed by the processor 410. Such instructions may include control instructions such as arithmetic and logical operations, data movement, and input/output that can be recognized by the processor 410.

According to an embodiment, the processor 410 is a component capable of performing calculations or data processing related to control and/or communication of individual components of the electronic device 400, and may be composed of one or more processors. The processor 410 may include at least some of the configurations and/or functions of the processor 120 in FIG. 1. The processor 410 may be operably, functionally, and/or electrically connected, directly or indirectly, to individual components of the electronic device 400, such as the display 200, camera module 430, sensor 440, and memory 420. Although there is no limitation to the computational and data processing functions that the processor 410 can implement on the electronic device 400, the disclosure will describe various embodiments in which the processor 410 determines the z-axis direction position of a graphical object based on the attributes of the graphical object and renders a 3D image so that it can be recognized at the determined z-axis direction position. The operations of the processor 410 to be described later can be performed by loading instructions stored in the memory 420.

In this disclosure, a description that the processor 410 (or electronic device 400) can perform a specific operation (or, function, job, or task) may be interpreted as having substantially the same meaning as that instructions (or, commands, computer programs) causing the electronic device 400 (or processor 410) to perform the corresponding operation are stored in the memory 420 (e.g., non-volatile memory, storage). Additionally, a description that the processor 410 can perform a specific operation may be interpreted as having substantially the same meaning as that at least one unspecified processor can perform the corresponding operation.

According to an embodiment, the electronic device 400 may render a 2D image or a 3D image and output it through the display 200. For example, the processor 410 may generate a first image (or left-eye image) and a second image (or right-eye image) constituting a 3D image, and assign pixel data of the first image to odd-numbered pixel columns (or pixel column groups including pixels) and assign pixel data of the second image to even-numbered pixel columns (or pixel column groups including pixels), thereby generating the 3D image. When the 3D image is output through the display 200, according to the optical structure such as a lenticular lens or a parallax barrier, only the first image may be substantially recognized by the user's left eye, and only the second image may be substantially recognized by the user's right eye.

According to an embodiment, the image output through the display 200 may include at least one graphical object. Here, the graphical object may include at least one of, but not limited to, a widget, an icon, an application execution screen, or a pop-up window. Widgets are described as an example of a graphical object i n the following description, but the embodiments described below can also be applied to other types of graphical objects other than widgets.

According to an embodiment, the processor 410 may generate a graphical object as a 2D graphical object or 3D graphical object, and may compose a 3D image by using the 2D graphical object and/or 3D graphical object. For example, although both a first graphical object and a second graphical object displayed within the image are 2D graphical objects, if the z-axis positions of the first and second graphical objects are different, the user may perceive a three-dimensional effect. A 3D image may include at least one 2D graphical object and at least one 3D graphical object, and at least one 2D or 3D graphical object may be recognized at a different position in the z-axis direction from other graphical objects.

According to an embodiment, the processor 410 may construct a 3D image in multiple planes. Here, the plane refers to a virtual surface in the z-axis direction on which a graphical object is formed, and may also be referred to as a layer, a panel, a level, or the like.

According to an embodiment, individual planes may be perceived by the user at positions spaced apart from each other in the z-axis direction. For example, the multiple planes may include a first plane formed outside the electronic device 400 (or closer to the user's gaze) in the z-axis direction from the display 200, a second plane formed at the position of the display 200, and a third plane formed inside the electronic device 400 (or farther from the user's gaze) in the z-axis direction from the display 200. In the following description, the first plane may be referred to as an air plane, the second plane as a surface plane, and the third plane as a core plane. In the following description, the electronic device 400 will be described as arranging graphical objects on three planes, but the number and/or positions of the planes constituting a 3D image are not limited thereto. Alternatively, the electronic device 400 may arrange graphical objects according to their z-axis coordinate values without composing a plurality of planes spaced apart from each other in the z-axis direction.

According to an embodiment, the processor 410 may detect a 3D trigger event while an image including a first graphical object and a second graphical object is displayed. Here, the 3D trigger event may be an event that, if the image to be displayed includes a first graphical object and a second graphical object that overlap each other at least partially on a plane, causes generation of a 3D image by separating the z-axis direction positions of the first and second graphical objects. For example, when an image (e.g., home screen) includes multiple graphical objects, if a first graphical object and a second graphical object among them overlap each other at least partially on a plane such that one hides at least a portion of the other, the processor 410 may perform an operation to represent the first graphical object and the second graphical object as a 3D graphical object. According to an embodiment, the 3D trigger event may be generated by a long touch input or long hovering input to the first graphical object and/or the second graphical object, a drag and drop input of the first graphical object onto the second graphical object, or a touch or hovering input to a given button.

According to an embodiment, if the image includes a first graphical object and a second graphical object at least partially overlapping the first graphical object, and/or if a 3D trigger event occurs based on a preset user input, the processor 410 may determine the z-axis direction positions at which the first graphical object and the second graphical object are to be located on a 3D image. For example, the processor 410 may determine whether to place the first graphical object and the second graphical object on the first plane, the second plane, or the third plane.

According to an embodiment, the processor 410 may determine the z-axis direction positions at which the first and second graphical objects are to be placed on a 3D image based on the attributes of the first and second graphical objects. Here, the attributes of the first graphical object and the second graphical object may include the size of the graphical object and characteristics of user interactions defined for the graphical object.

According to an embodiment, the processor 410 may determine the z-axis direction positions of the first graphical object and the second graphical object on a 3D image based on the sizes of the first graphical object and the second graphical object. The processor 410 may place the smaller graphical object among the first and second graphical objects above the larger graphical object in the z-axis direction (or in +z direction). For example, if the first graphical object is moved and placed to overlap with the second graphical object according to a user input (e.g., drag and drop after long touch), the processor 410 may determine the z-axis position of the relatively large second graphical object to be the second plane (or surface plane), and determine the z-axis position of the relatively small first graphical object to be the first plane (or air plane).

According to an embodiment, the processor 410 may determine the z-axis direction positions at which the first graphical object and the second graphical object are to be placed on a 3D image based on the characteristics of preset user interactions for the first graphical object and the second graphical object. For example, user interaction characteristics may be determined based on the number of selectable items (or interaction components) contained in the graphical object, the frequency of user interactions, and/or the type of user interactions. Here, a selectable item may be an item that is set to execute a specified function when selected by the user on a graphical object.

According to an embodiment, if the first graphical object includes a selectable item and the second graphical object does not include a selectable item, the processor 410 may place the first graphical object above the second graphical object in the z-axis direction (or in +z direction). The second graphical object not including a selectable item is intended to provide information, and the first graphical object requires user input, so the first graphical object may be placed above for easy user input.

According to an embodiment, if both the first graphical object and the second graphical object include a selectable item, the processor 410 may place the graphical object with a greater number of selectable items above the graphical object with a smaller number of selectable items on the z-axis.

According to an embodiment, the processor 410 may determine the z-axis direction positions of the first graphical object and the second graphical object based on the frequency of user interactions with the first and second graphical objects. Here, the frequency of user interactions may be predetermined by the attribute information of the corresponding graphical object, and/or determined based on the history of user interactions in the electronic device 400. For example, the electronic device 400 may place a graphical object including a selectable item that has a high frequency of actual selections on the electronic device 400 at an upper position.

According to an embodiment, the processor 410 may place a graphical object including a small-sized selectable item at an upper position, place a graphical object having a high 3D effect score specified by its attribute information at an upper position, and/or place, when a first graphical object and a second graphical object are moved to overlap, the graphical object moved by user input at an upper position.

According to an embodiment, the processor 410 may determine the Z-axis direction positions of the first graphical object and the second graphical object based on the type of user interaction with the first graphical object and the second graphical object. For example, the processor 410 may place a widget (e.g., music widget) including items controlled according to a touch input on the second plane (or surface plane) that has the same z-axis position as the display 200 where an actual touch input is detected, and may place a widget (e.g., gallery widget) including items controlled according to a hovering input (or gesture input) on the first plane (or air plane) where an actual hovering input is detected.

According to an embodiment, when a 3D trigger event is detected, the processor 410, comprising processing circuitry, may compare the sizes of the first graphical object and the second graphical object, and, if the size difference is greater than or equal to a reference value, determine the z-axis direction positions of the first graphical object and the second graphical object based on the sizes of the first and second graphical objects. Additionally, if the size difference between the first graphical object and the second graphical object is less than the reference value, the processor 410 may determine the z-axis direction positions of the first graphical object and the second graphical object based on preset user interaction characteristics for the first graphical object and the second graphical object.

According to an embodiment, the processor 410 may render a first image (or left-eye image) and a second image (or right-eye image) constituting a 3D image based on the z-axis direction positions determined for the first graphical object and the second graphical object, and output the same through the display 200.

According to an embodiment, while a 3D image is displayed, the processor 410 may activate a 3D editing mode based on a user input, and change the z-axis direction positions of the first graphical object and/or the second graphical object. For example, when a user's long touch input is detected for the first graphical object while the first graphical object is placed on the first plane and the second graphical object is placed on the second plane, the processor 410 may display an item that can move the first graphical object to another plane, and move the first graphical object to the second plane or the third plane according to a user input on the item.

According to an embodiment, the electronic device 400 may detect a user input in the z-axis direction on the display 200. For example, if the user touches a region of the display 200 and presses the region hard in the −z direction, the processor 410 may detect a change in pressure intensity and determine it as an input in the −z direction. In addition, if the user touches a region of the display 200 using a finger or stylus 450 and gradually moves the touch away from the display 200, the processor 410 may detect a change in capacitance and determine it as an input in the +z direction. In 3D editing mode, the processor 410 may change the z-axis direction position of a graphical object based on a user input in the z-axis direction.

According to an embodiment, in 3D editing mode, the electronic device 400 may change the z-axis direction positions of all displayed graphical objects according to user input. For example, when a user input to move a graphical object in the −z direction is detected while a first graphical object is placed on the first plane and a second graphical object is placed on the second plane, the electronic device 400 may move the first graphical object to the second plane and the second graphical object to the third plane.

According to an embodiment, the processor 410 may track the user's gaze position based on images obtained from the camera module 430, and determine the position of a graphical object displayed on the 3D image based on the gaze position. For example, the processor 410 may obtain a user's pupil image in real time by using the front camera module 430 and track the gaze position based on changes in pupil position. When the user is viewing the electronic device 400 in the +x direction, the processor 410 may move the graphical object in the −x direction. Consequently, the side surface of the graphical object can be recognized by the user, and various information can be provided to the user through the side surface of the graphical object.

According to an embodiment, the processor 410 may detect the inclination of the electronic device 400 by using at least one sensor 440 (e.g., acceleration sensor, gyro sensor) and change the graphical objects displayed on the 3D image based on the inclination. For example, if the user tilts the electronic device 400 sideways, the user may recognize the side surface of a graphical object, so it is possible to provide new information through the side surface. In this case, the processor 410 may increase the area of the side surface of each graphical object and/or increase the distance between graphical objects.

Those instructions for executing the operations of the electronic device 400 (or processor 410) described above may be included in a computer-readable recording medium. This recording medium may be tangible and non-transitory. The recording medium may store one or more computer programs including the above instructions.

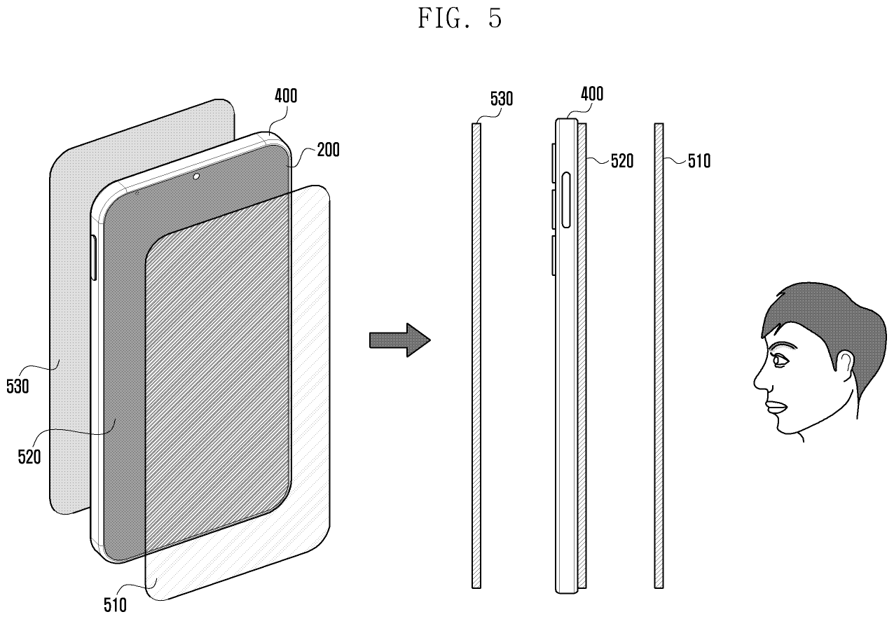

FIG. 5 illustrates an example of 3D planes formed in the z-axis direction from the display according to an embodiment.

According to an embodiment, the electronic device 400 (e.g., electronic device 400 in FIG. 4) may compose the region where graphical objects are placed in a 3D image in plural planes. Here, the plane refers to a virtual surface in the z-axis direction on which graphical objects are formed, and may also be referred to as a layer, panel, level, or the like.

According to an embodiment, individual planes 510, 520 and 530 may be recognized by the user at positions spaced apart from each other in the z-axis direction. With reference to FIG. 5, the electronic device 400 may compose a first plane 510 (or, air plane, outside layer) formed outside the electronic device 400 in the z-axis direction from the display 200, a second plane 520 (or, surface plane, display layer) formed at the position of the display 200, and a third plane 530 (or, core plane, inside layer) formed inside the electronic device 400 in the z-axis direction from the display 200. When the user views a 3D image from the front of the display 200, the first plane 510, the second plane 520, and the third plane 530 may be perceived as closer in that order.

According to an embodiment, the electronic device 400 may determine the z-axis direction position of each graphical object (e.g., first graphical object, second graphical object) constituting a 3D image to be one of the first plane 510, the second plane 520, and the third plane 530.

FIG. 5 illustrates three planes 510, 520 and 530 on which graphical objects are placed, but the number of planes is not limited thereto. Alternatively, the electronic device 400 may determine the z-axis direction position of a graphical object as a z-axis coordinate value other than a specific plane, and generate a 3D image according to the coordinate values of graphical objects.

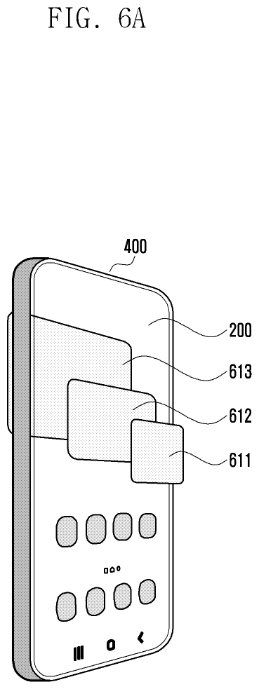

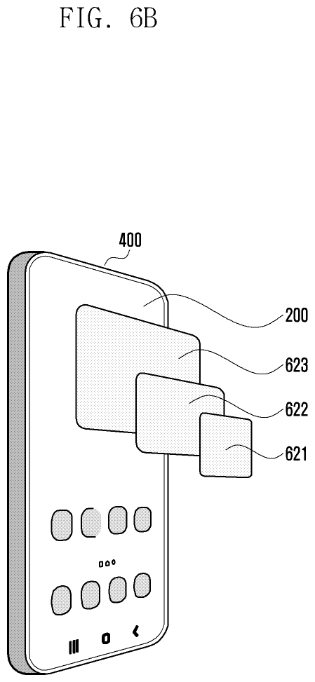

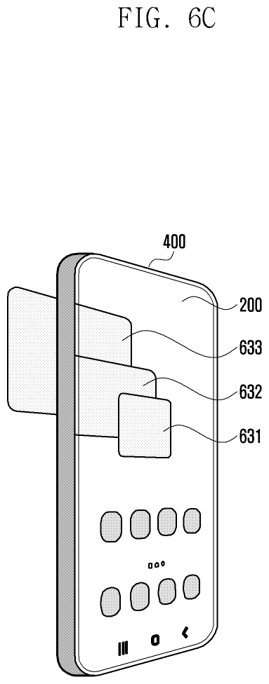

FIGS. 6A, 6B and 6C illustrate an example of 3D planes formed in the z-axis direction from the display according to an embodiment.

According to an embodiment, for implementing a 3D image, the electronic device 400 may compose at least one plane in an upward direction (or +z direction) closer from the user and/or in a downward direction (or −z direction) farther from the user with respect to the display 200.

With reference to FIG. 6A, the electronic device 400 may include, with respect to the z-axis direction, a second plane 612 formed at substantially the same position as the display 200, a first plane 611 formed above the display 200 (or, in +z direction), and a third plane 613 formed below the display 200 (or, in −z direction). In the example of FIG. 6A, graphical objects may be placed above and below the display 200.

With reference to FIG. 6B, the electronic device 400 may include a third plane 623 formed at substantially the same position as the display 200, a second plane 622 formed above (or, in z direction) the third plane 623, and a first plane 621 formed above the second plane 622. In the example of FIG. 6B, at least one graphical object may be placed above (or outside) the display 200.

With reference to FIG. 6C, the electronic device 400 may include a first plane 631 formed at substantially the same position as the display 200, a second plane 632 formed below (or, in-z direction) the first plane 631, and a third plane 633 formed below the second plane 632. In the example of FIG. 6C, at least one graphical object may be placed below (or inside) the display 200.

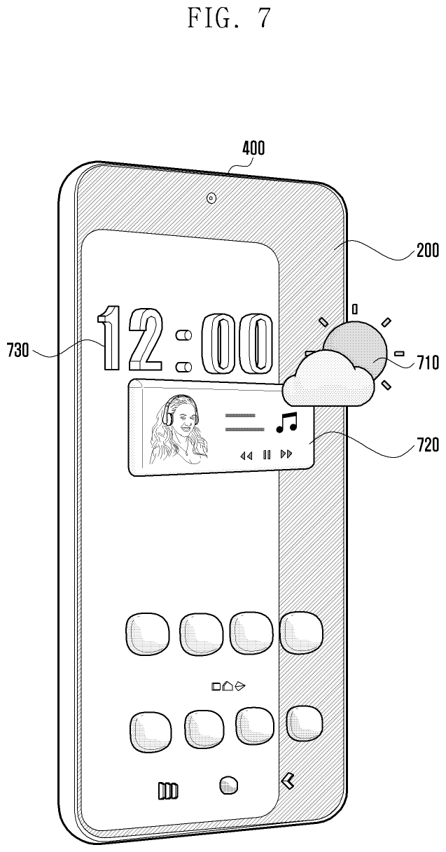

FIG. 7 illustrates graphical objects arranged on 3D planes according to an embodiment.

With reference to FIG. 7, the 3D image rendered by the electronic device 400 may include a clock widget 730, a music widget 720, and a weather widget 710 as graphical objects. Among them, the clock widget 730 may be a 3D graphical object having a three-dimensional effect in itself, and the music widget 720 and weather widget 710 may be a 2D graphical object in a flat form.

According to an embodiment, when a 3D trigger event is detected, the electronic device 400 may determine the z-axis direction position of each graphical object. For example, if the clock widget 730, the music widget 720, and the weather widget 710 in the image at least partially overlap, for example, if at least one of the widgets 710, 720 and 730 is moved according to a user input to overlap with at least one other widget, the electronic device 400 may detect occurrence of a 3D trigger event.

According to an embodiment, the electronic device 400 may determine the plane on which a specific graphical object is to be placed to be one of the first plane (e.g., first plane 510 in FIG. 5), the second plane (e.g., second plane 520 in FIG. 5), and the third plane (e.g., third plane 530 in FIG. 5) based on the attributes of the graphical object (e.g., size, user interaction characteristics). Referring to FIG. 7, the electronic device 400 may determine to place the weather widget 710 on the first plane (or air plane), the music widget 720 on the second plane (or surface plane), and the clock widget 730 on the third plane (or core plane). The electronic device 400 may place a graphical object (e.g., application icon), which does not overlap with another graphical object in the screen and is not composed in 3D, on the second plane, so that it is recognized at the same position as when displayed as a 2D image.

According to an embodiment, based on the z-axis direction position of each graphical object determined in this manner, the electronic device 400 may render a first image (or left-eye image) and a second image (or right-eye image) that constitute a 3D image.

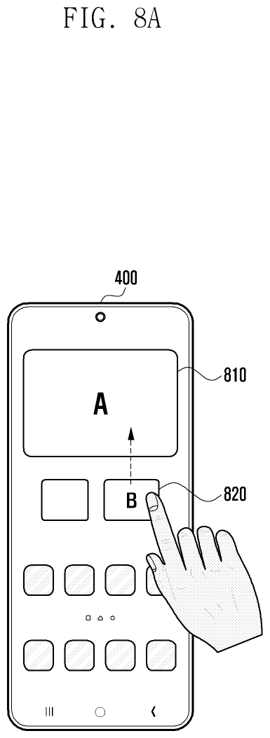

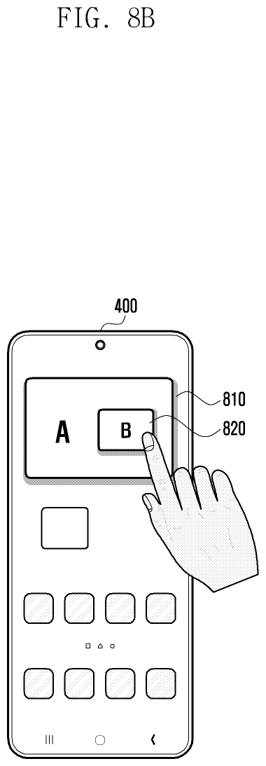

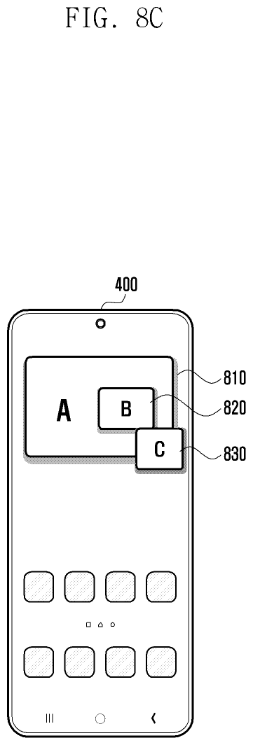

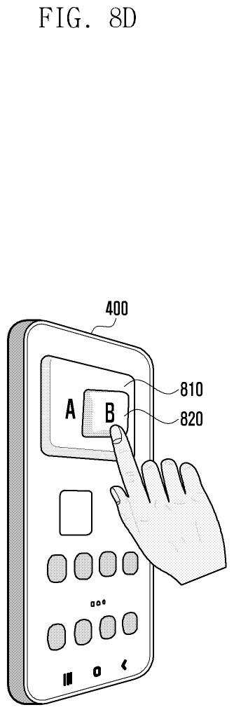

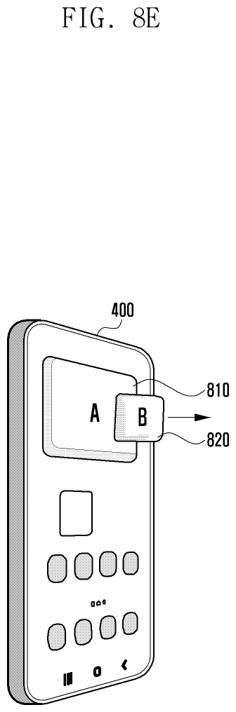

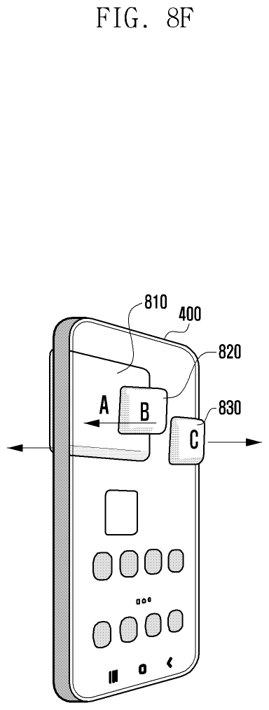

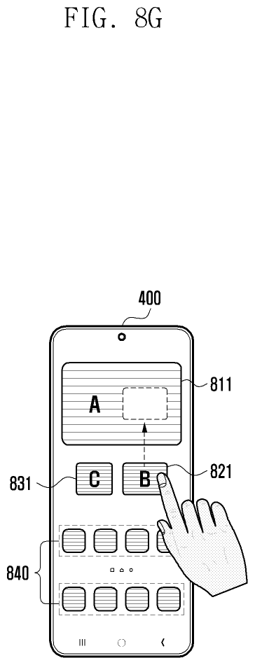

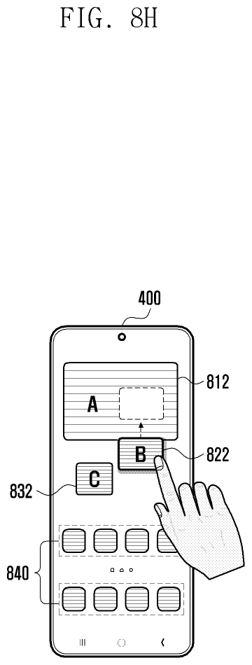

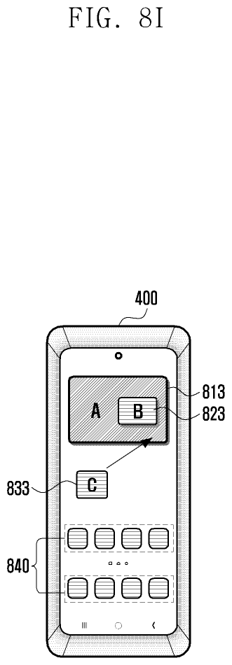

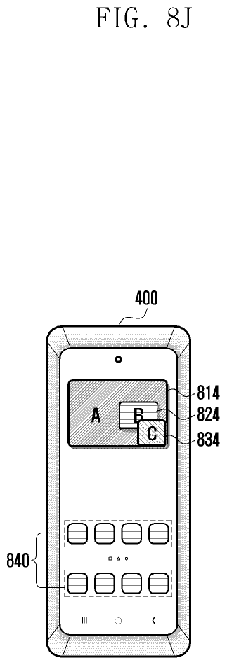

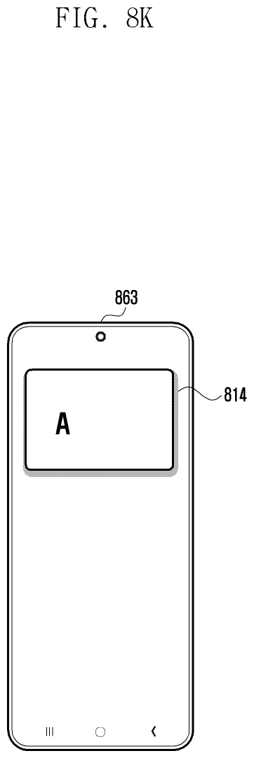

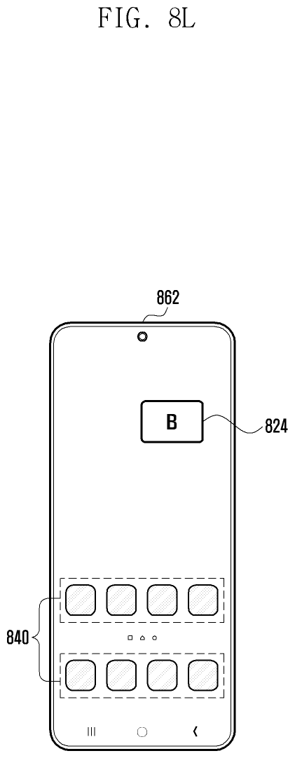

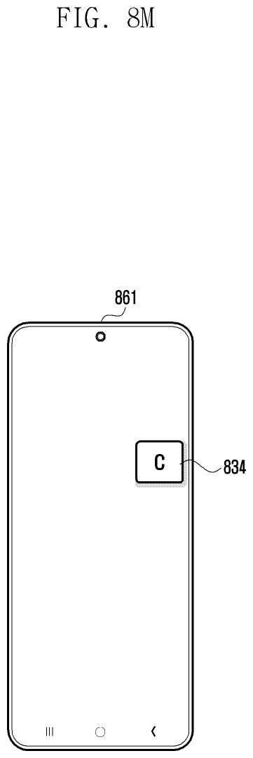

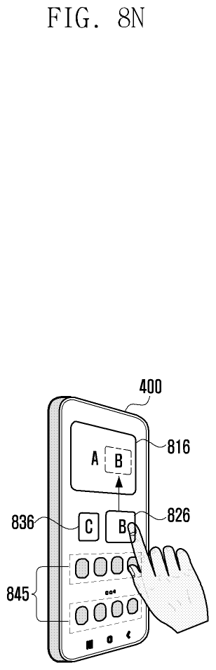

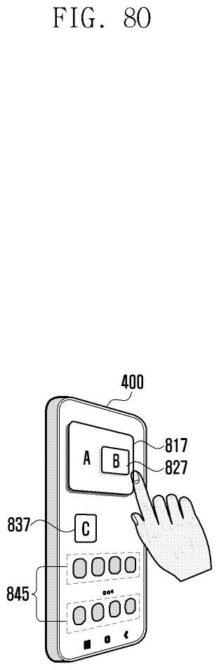

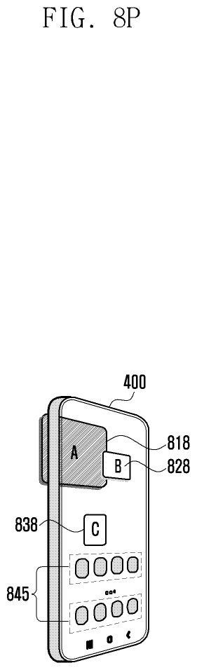

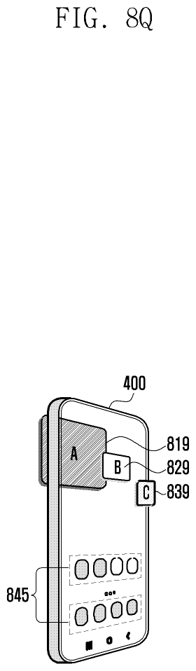

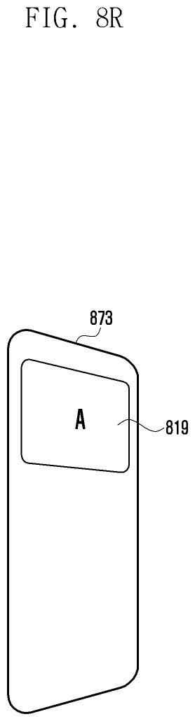

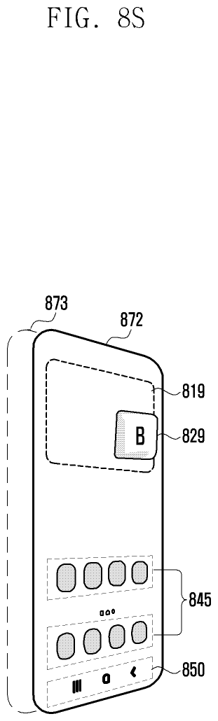

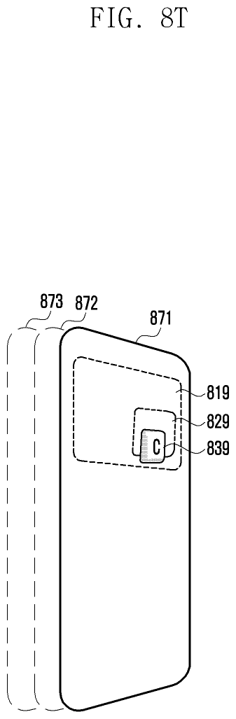

FIGS. 8A, 8B, 8C, 8D, 8E, 8F, 8G, 8H, 8I, 8J, 8K, 8L, 8M, 8N, 8O, 8P, 8Q, 8R, 8S and 8T illustrate a method of stacking and arranging graphical objects in accordance with their attributes according to an embodiment.

According to an embodiment, when an image to be displayed includes a first graphical object and a second graphical object that at least partially overlaps the first graphical object, and/or when a 3D trigger event occurs in response to a user input for a graphical object, the electronic device 400 may determine the z-axis direction position of each graphical object.

According to an embodiment, the electronic device 400 may determine the z-axis positions at which the first and second graphical objects are to be placed on a 3D image based on the attributes of the first and second graphical objects. Here, the attributes of the first and second graphical objects may include the size of each graphical object and/or user interaction characteristics specified for the graphical object. For example, in FIGS. 8A to 8T, graphical objects A, B, and C may have a larger size in that order, and if two or more graphical objects overlap in response to a user input, a graphical object with a relatively smaller size may be placed on a plane above a graphical object with a relatively larger size in the z-axis direction.

With reference to FIG. 8A, while the display outputs an image including graphical object A 810 and graphical object B 820 in 2D display mode, the electronic device 400 may detect a user input for moving graphical object B 820 above graphical object A 810. For example, when a long press is detected on graphical object B 820, graphical object B 820 transitions to a movable state, and when the touch is maintained and dragged toward graphical object A 810, graphical object B 820 may be moved according to the drag position.

With reference to FIG. 8B, when the user drags graphical object B 820 over graphical object A 810 and then releases (or drops) the touch, graphical object A 810 and graphical object B may overlap each other. The electronic device 400 may compare the attributes of overlapping graphical object A 810 and graphical object B 820 to determine whether 3D space arrangement is possible, and if so, the electronic device 400 may transition to 3D display mode. For example, the electronic device 400 may determine whether 3D space arrangement is possible by checking whether the size difference between overlapping graphical object A 810 and graphical object B 820 is greater than or equal to a threshold value, whether there is information to be displayed in 3D form, and/or the touch interaction type for the graphical object.

According to an embodiment, when transitioning to 3D display mode, the electronic device 400 may determine the z-axis direction positions of graphical object A 810 and graphical object B 820 based on the attributes of graphical object A 810 and graphical object B 820. The electronic device 400 may compare the sizes of graphical object A 810 and graphical object B 820, and determine the z-axis direction position of smaller graphical object B 820 to be higher (or in +z direction) than graphical object A 810. For example, the electronic device 400 may determine the position of smaller graphical object B 820 to be the first plane (e.g., first plane 510 in FIG. 5) and the position of larger graphical object A 810 to be the second plane (e.g., second plane 520 in FIG. 5).

According to an embodiment, when transitioning to 3D display mode, the electronic device 400 may convert a graphical object among graphical object A 810 and graphical object B 820 that can be converted into a 3D form into a 3D form.

According to an embodiment, if the comparison of the attributes between graphical object A 810 and graphical object B 820 indicates that 3D space arrangement is not possible, the electronic device 400 may display graphical object A 810 and graphical object B 820 in a stacked manner on a 2D screen while maintaining 2D display mode. For example, the electronic device 400 may determine to use 2D stacking mode if the sizes of graphical objects A 810 and graphical object B 820 are substantially the same.

With reference to FIG. 8C, while graphical object A 810 and graphical object B 820 are displayed in 3D display mode, graphical object C 830 may be moved to overlap with graphical object A 810 and graphical object B 820. For example, when transitioning to 3D display mode, if graphical object C 830 is placed on the first plane, the position of graphical object C 830 may be moved through a hovering input, and if it is placed on the second plane or third plane, the position of graphical object C 830 may be moved through a touch input.

According to an embodiment, the electronic device 400 may determine the z-axis direction positions based on the attributes of overlapping graphical objects A 810, B 820, and C 830. For example, since graphical object C 830 is smaller in size than graphical object A 810 and substantially the same in size as graphical object B 820 but has a relatively high frequency of user interaction, the electronic device 400 may determine the z-axis direction position of graphical object C 830 to be higher than graphical object A 810 and graphical object B 820. Based on the z-axis direction positions determined in this way, the electronic device 400 may place graphical object C 830 on the first plane, graphical object B 820 on the second plane, and the graphical object A 810 on the third plane.

According to an embodiment, the electronic device 400 may generate a 3D image such that the multiple planes, each including at least one graphical object, may be recognized by the user at different positions spaced apart from each other by a preset distance in the z-axis direction. Here, the distance between planes may be determined in advance, and may be changed based on the number of planes constituting a 3D image and/or user input.

With reference to FIG. 8D, when the user moves graphical object B 820 to overlap with graphical object A 810, the electronic device 400 may transition to 3D display mode and determine the z-axis direction positions of graphical object A 810 and graphical object B 820. For example, the position of smaller graphical object B 820 may be determined to be the first plane, and the position of larger graphical object A 810 may be determined to be the second plane.

With reference to FIG. 8E, the electronic device 400 may move graphical object B 820 upward from the vertical direction of the display (or in +z direction) so that graphical object B 820 is formed on the first plane. Graphical object A 810 and graphical object B 820 may be recognized by the user as being spaced apart by a preset distance in the z-axis direction.

With reference to FIG. 8F, as graphical object C 830 overlaps with graphical object A 810 and graphical object B 820 in response to a user input, the electronic device 400 may determine, based on the attributes of each graphical object, to place graphical object C 830 on the first plane, graphical object B 820 on the second plane, and graphical object A 810 on the third plane. Hence, the electronic device 400 may move graphical object A 810 from the second plane to the third plane, which is further downward from the vertical direction of the display (or in-z direction), move graphical object B 820 to the second plane, and move graphical object C 830 to the first plane.

According to an embodiment, when two or more graphical objects overlap with each other, the electronic device 400 may transition to 3D display mode and at least partially simultaneously change at least one of the overlapping graphical objects into a 3D graphical object. For example, at the time when two or more graphical objects overlap each other, the electronic device 400 may check whether they can be changed into a 3D object, and change a changeable graphical object into a 3D object.

With reference to FIG. 8G, in 2D display mode, the electronic device 400 may display graphical object A 811, graphical object B 821, graphical object C 831, and home screen icons 840. In this case, graphical object A 811, graphical object B 821, graphical object C 831, and home screen icons 840 may be 2D graphical objects.

According to an embodiment, the electronic device 400 may detect a user input for moving graphical object B 821 over graphical object A 811. For example, the user input may be a long press followed by a drag input.

With reference to FIG. 8H, if graphical object A 812 and graphical object B 822 overlap due to movement of graphical object B 822, the electronic device 400 may change graphical object A 812 and graphical object B 822 into a 3D graphical object. For example, at the time when the edges of graphical object A 812 and graphical object B 822 overlap in the vertical direction, the electronic device 400 may check whether graphical object A 812 and graphical object B 822 can be changed into a 3D object, and change at least one changeable object among them into a 3D graphical object. In this case, graphical object C 832 and home screen icons 840 may remain as a 2D graphical object.

According to an embodiment, while graphical object A 812 and graphical object B 822 are overlapping, the electronic device 400 may change graphical object A 812 and graphical object B 822 into a 3D graphical object until the user input is released, but may display graphical object A 812, graphical object B 822, graphical object C 832, and home screen icons 840 on the same plane in 2D display mode.

According to an embodiment, when the user input is released, e.g., when graphical object B 823 is dragged and dropped at a position overlapping with graphical object A 813, the electronic device 400 may transition to 3D display mode by moving the graphical objects to plural planes.

With reference to FIG. 8I, when graphical object B 823 is dropped, the electronic device 400 may display larger graphical object A 813 on the third plane and smaller graphical object B 823 on the second plane. In this case, graphical object C 833 and home screen icons 840 may be displayed on the second plane while maintaining their 2D graphical object form.

With reference to FIG. 8J, the electronic device 400 may receive additional user input for moving graphical object C 834. Graphical object A 814 and graphical object B 824 already in overlapping state may remain as a 3D graphical object, and graphical object C 834 may be changed into a 3D graphical object from the moment it overlaps with graphical object A 814 or graphical object B 824 (e.g., at the time when the edge of graphical object C 834 meets the edge of graphical object A 814). When the user drops the graphical object C 834 while it is overlapping with graphical object A 814 or graphical object B 824, graphical object A 814 may be displayed on the third plane, graphical object B 824 on the second plane, and graphical object C 834 on the first plane. In this case, the home screen icons 840 may be displayed on the second plane as they are while maintaining the form of 2D graphical objects.

FIGS. 8D to 8M illustrate the planes on which graphical objects shown in FIG. 8J are placed.

With reference to FIG. 8K, graphical object A 814 may be placed on the third plane 863 as a 3D graphical object. For example, at the time when graphical object B 824 overlaps with graphical object A 814, the electronic device 400 may compare the sizes of graphical object A 814 and graphical object B 824, and place larger graphical object A 814 on the third plane 863, which is formed inside the electronic device 400 (or, on the side farther from the user's gaze) in the z-axis direction.

With reference to FIG. 8L, graphical object B 824 may be placed on the second plane 862 as a 2D graphical object. Home screen icons 840 may be displayed on the second plane while maintaining the form of a 2D graphical object.

With reference to FIG. 8M, graphical object C 834 may be placed on the first plane 861 as a 3D graphical object. For example, at the time when graphical object C 834 overlaps with graphical object B 824, the electronic device 400 may compare the interaction attributes of graphical object C 834 and graphical object B 824, and place graphical object B 824 having a touch input attribute on the second plane, and place graphical object C 834 having a hovering input attribute on the first plane 861 formed outside the electronic device 400 in the z-axis direction (or, on the side closer to the user's gaze).

According to an embodiment, if two or more graphical objects overlap each other, the electronic device 400 may transition to 3D display mode and at least partially simultaneously change at least one of the overlapping graphical objects into a 3D graphical object. For example, if two or more graphical objects overlap each other, the electronic device 400 may check whether the graphical objects can be changed into a 3D object at the time when the touch input for the moved graphical object is released, and may change a changeable graphical object into a 3D object.

With reference to FIG. 8N, the electronic device 400 may display graphical object A 816, graphical object B 826, graphical object C 836, and home screen icons 845 in 2D display mode. In this case, graphical object A 816, graphical object B 826, graphical object C 836, and home screen icons 845 may be a 2D graphical object.

According to an embodiment, the electronic device 400 may detect a user input for moving graphical object B 826 over graphical object A 816. For example, the user input may be a long press followed by a drag input.

With reference to FIG. 8O, while graphical object A 817 and graphical object B 827 are overlapping due to movement of graphical object B 827, when the user input for graphical object B 827 is released, the electronic device 400 may change graphical object A 817 and graphical object B 827 into a 3D graphical object. For example, at the time when the user input for graphical object B 827 is released, the electronic device 400 may check whether overlapping graphical objects A 817 and B 827 can be changed into a 3D object, and change at least one of the changeable objects into a 3D graphical object. In this case, graphical object C 837 and home screen icons 845 may remain as a 2D graphical object.

According to an embodiment, when the user input is released, e.g., when graphical object B 828 is dragged and then dropped at a position overlapping with graphical object A 818, the electronic device 400 may change each graphical object into a 3D graphical object, and/or transition to 3D display mode by moving the graphical objects to the plural planes.

With reference to FIG. 8P, when graphical object B 828 is dropped, the electronic device 400 may display larger graphical object A 818 on the third plane and smaller graphical object B 828 on the second plane. In this case, graphical object C 838 and home screen icons 845 may be displayed on the second plane while maintaining the form of a 2D graphical object.

With reference to FIG. 8Q, the electronic device 400 may receive additional user input for moving and then releasing graphical object C 839. Graphical object A 819 and graphical object B 829 already in overlapping state may remain as a 3D graphical object, and graphical object C 839 may be changed into a 3D graphical object from the time when the user input is released after graphical object C 839 overlaps with graphical object A 819 or graphical object B 829. When the user drops graphical object C 839 in a state overlapping with graphical object A 819 or graphical object B 829, graphical object A 819 may be displayed on the first plane, graphical object B 829 on the second plane, and graphical object C 839 on the third plane. In this case, home screen icons 845 may be displayed on the second plane as they are while maintaining the form of a 2D graphical object.

FIGS. 8R, 8S and 8T illustrate the planes on which graphical objects shown in FIG. 8Q are placed.

With reference to FIG. 8R, graphical object A 819 may be placed on the third plane 873 as a 3D graphical object. For example, at the time when the user input is released after graphical object B 829 overlaps with graphical object A 819, the electronic device 400 may compare the sizes of graphical object A 819 and graphical object B 829, and place larger graphical object A 819 on the third plane 873 formed inside the electronic device 400 in the z-axis direction (or, on the side farther from the user's gaze).

With reference to FIG. 8S, graphical object B 829 may be placed on the second plane 872 as a 2D graphical object. Home screen icons 845 may be displayed on the second plane while maintaining the form of a 2D graphical object.

With reference to FIG. 8T, graphical object C 839 may be placed on the first plane 871 as a 3D graphical object. For example, at the time when the user input is released after graphical object C 839 overlaps with graphical object B 829, the electronic device 400 may compare the interaction attributes of graphical object C 839 and graphical object B 829, and place graphical object B 829 having a touch input attribute on the second plane, and place graphical object C 839 having a hovering input attribute on the first plane 871 formed outside the electronic device 400 in the z-axis direction (or, on the side closer to the user's gaze).

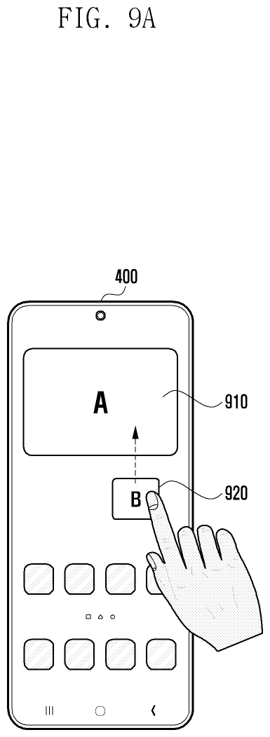

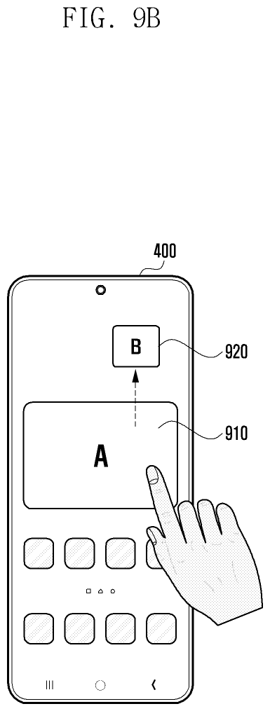

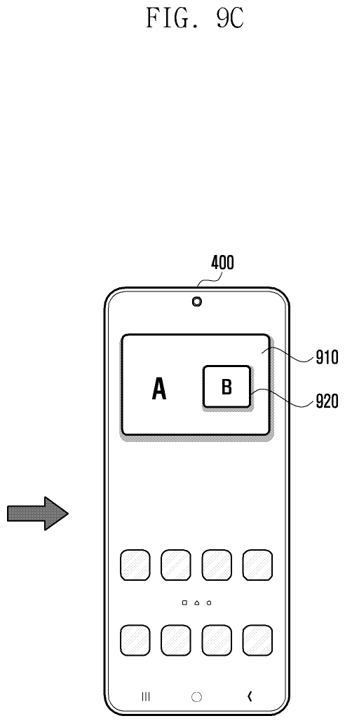

FIGS. 9A, 9B and 9C illustrate a method of arranging graphical objects in a stacked manner in accordance with their attributes according to an embodiment.

According to an embodiment, when composing a 3D image, the electronic device 400 may determine the z-axis direction positions of the first graphical object and the second graphical object based on their sizes. For example, the electronic device 400 may place a smaller graphical object on the plane upward (or in +z direction) from the z-axis direction.

With reference to FIG. 9A, while graphical object A 910 and graphical object B 920 are displayed in 2D display mode, a user input that selects smaller graphical object B 920 and moves it to overlap with larger graphical object A 910 may be detected.

With reference to FIG. 9B, while graphical object A 910 and graphical object B 920 are displayed in 2D display mode, a user input that selects graphical object A 910 and moves it to overlap with graphical object B 920 may be detected.

According to an embodiment, when displaying graphical object A 910 and graphical object B 920 overlappingly in 2D display mode, the electronic device 400 may place the graphical object selected and moved by user input at the top. For example, when graphical object B 920 is moved as in FIG. 9A, graphical object B 920 is placed above, and when graphical object A 910 is moved as in FIG. 9B, graphical object A 910 is placed above, so that they may overlap each other on a 2D image. In 2D display mode, pages are generated within a 2D image, and since it is assumed that the user will turn the pages by a swipe input, it can be a rule to display the widget selected by user input at the top.

According to an embodiment, the electronic device 400 may determine the z-axis direction positions of graphical object A 910 and graphical object B 920 in 3D display mode based on the attributes (e.g., sizes) of graphical object A 910 and graphical object B 920. With reference to FIG. 9C, the electronic device 400 may compare the sizes of overlapping graphical objects A 910 and B 920 and place smaller graphical object B 920 above in the z-axis direction (or, in +z direction). For example, when graphical object B 920 is moved as in FIG. 9A, and when graphical object A 910 is moved as in FIG. 9B, the electronic device 400 may place smaller graphical object B 920 on top as in FIG. 9C. In 3D display mode, placing the smaller graphical object on top less hides the lower graphical object, enhancing the 3D effect. Hence, in 3D display mode, unlike stacking in 2D display mode, the z-axis direction position may be determined based on the attributes of the graphical object regardless of a graphical object moved by user input.

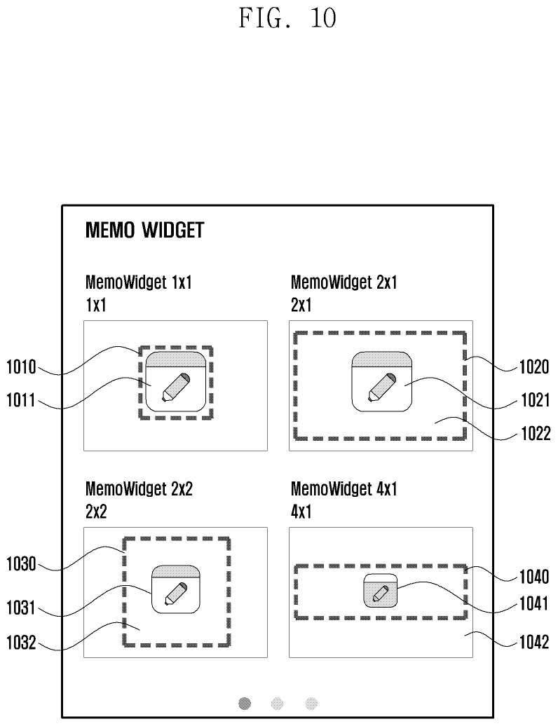

FIG. 10 illustrates a method for determining the size of a graphical object according to an embodiment.

According to an embodiment, to compose a 3D image, the electronic device (e.g., electronic device 400 in FIG. 4) may determine the z-axis direction positions of a first graphical object and a second graphical object based on their sizes. The electronic device may compare the sizes of graphical objects based on the regions where actual information is displayed among the regions occupied by the graphical objects.

FIG. 10 illustrates various forms of a memo widget, which is an example of a graphical object.

With reference to FIG. 10, the actual information region containing image information may occupy a portion of the region where a memo widget is set, and the remaining region may be processed as a transparent portion. For example, in the case of a 1*1 memo widget, the defined widget region 1010 and the actual information region 1011 may have substantially the same size. In contrast, for 2*1 memo widget, 2*2 memo widget, and 4*1 memo widget, the sizes of the widget regions 1020, 1030 and 1040 may differ from those of the actual information regions 1021, 1031 and 1041, and within the widget regions 1020, 1030 and 1040, there may be transparent regions 1022, 1032 and 1042 excluding the actual information regions 1021, 1031 and 1041. Since these transparent regions 1022, 1032 and 1042 do not have actual image information, other graphical objects placed under the transparent regions 1022, 1032 and 1042 in a 3D image may be recognized by the user.

According to an embodiment, the electronic device may determine the z-axis direction positions where graphical objects are to be placed by comparing only the sizes of the actual regions 1021, 1031 and 1041 containing image information of the graphical objects, excluding the transparent regions 1022, 1032 and 1042 that do not hide other graphical objects below even if displayed above.

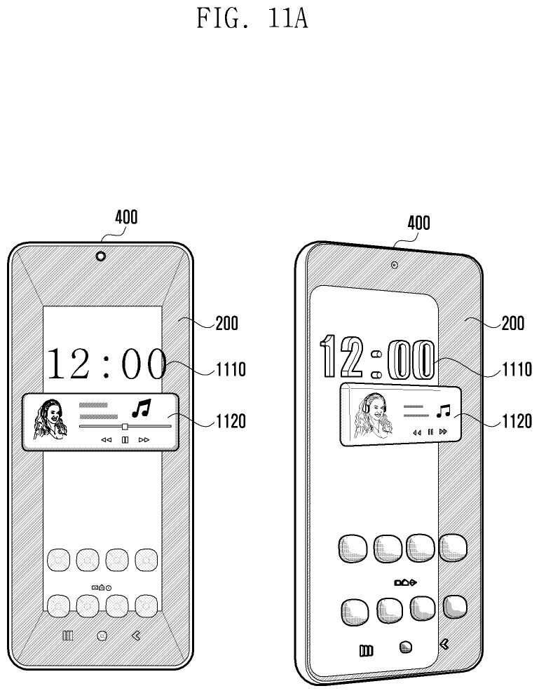

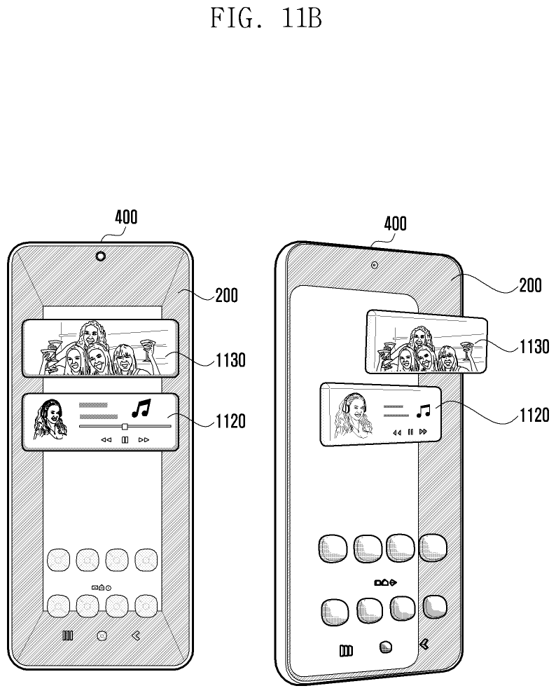

FIGS. 11A and 11B illustrate a method of stacking and arranging graphical objects based on the characteristics of user interaction with each graphical object according to an embodiment.

According to an embodiment, the electronic device 400 may determine the z-axis direction positions of a first graphical object and a second graphical object based on preset user interaction characteristics for the first graphical object and the second graphical object. For example, the user interaction characteristics may include the number of selectable items contained in a graphical object, the frequency of user interactions, and/or the type of user interactions. Here, the selectable item may be an item configured to execute a specified function upon user selection on the corresponding graphical object. According to an embodiment, the user interaction characteristics of a graphical object may be stored in advance in the attribute information of the graphical object, and the electronic device may identify the user interaction characteristics of the graphical object from the attribute information.

According to an embodiment, the electronic device 400 may determine the relative positions on the z-axis between graphical objects based on the usage pattern of the graphical objects. According to an embodiment, the electronic device 400 may determine the relative positions on the z-axis based on the characteristics of user interactions if the difference in size between two overlapping graphical objects is small and it is not useful to distinguish them by size, or if the graphical object is a large widget but serves for simple information display.

With reference to FIG. 11A, the 3D image may include a clock widget 1110 and a music widget 1120. Here, the music widget 1120 may be a graphical object with a high frequency of user interaction, as the user frequently uses functions such as play, pause, backward, and forward, and it includes selectable items corresponding to individual functions. Additionally, the clock widget 1110 is intended to display time information, may not have a selectable item, and may not frequently experience user interaction.

According to an embodiment, the electronic device 400 may place the music widget 1120, which frequently experiences user interaction, higher in the z-axis direction than the clock widget 1110, which less frequently experiences user interaction. For example, the electronic device 400 may place the music widget 1120 on the second plane (e.g., second plane 520 in FIG. 5) corresponding to the position of the display 200, and place the clock widget 1110 on the third plane (e.g., third plane 530 in FIG. 5) formed below the display 200.

With reference to FIG. 11B, the 3D image may include a music widget 1120 and a gallery widget 1130. Here, the music widget 1120 may include multiple selectable items, and each selectable item may be selected by touch input. Additionally, for the gallery widget 1130, swipe input by hovering may be mainly used. If the sizes of the music widget 1120 and the gallery widget 1130 do not differ significantly, the electronic device 400 may determine the placement position of each graphical object according to the characteristics of user interaction.

According to an embodiment, the electronic device 400 may determine the z-axis direction position of a graphical object based on the type of user interaction with the graphical object. For example, the music widget 1120 that can be controlled by touch input may be placed on the second plane corresponding to the position of the display 200, and the gallery widget 1130 that can be controlled by hovering input may be placed on the first plane (e.g., first plane 510 in FIG. 5) corresponding to the position of hovering input.

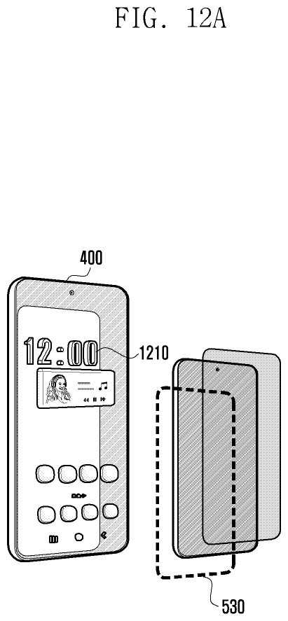

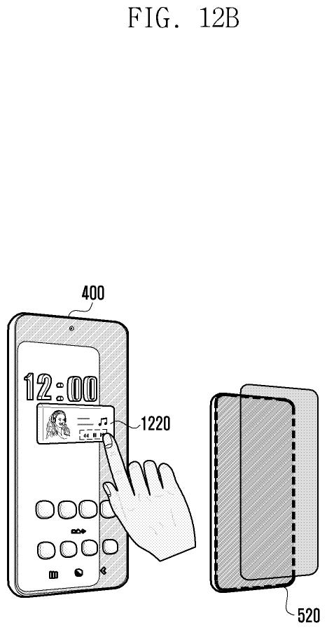

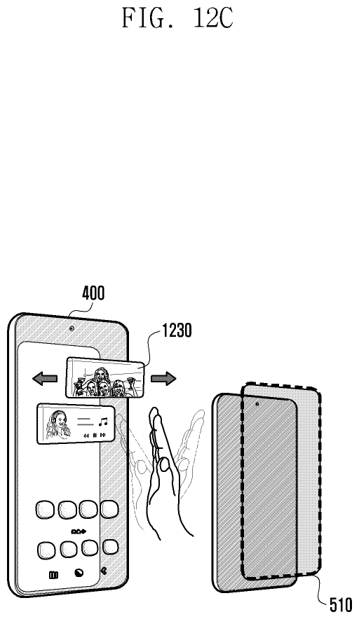

FIGS. 12A, 12B and 12C illustrate a method of stacking and arranging graphical objects based on the characteristics of user interaction with each graphical object according to an embodiment.

According to an embodiment, the electronic device 400 may determine the z-axis position of a graphical object based on the type of user interaction with the graphical object.

With reference to FIG. 12A, the clock widget 1210 may be intended to display time information, have no selectable items, and not experience frequent user interaction. The electronic device 400 may place a graphical object with a low frequency of user interaction and intended for information display, such as the clock widget 1210, on the third plane 530 (or, core plane) formed inside the display.

With reference to FIG. 12B, the music widget 1220 may include multiple items that can be selected via touch input. The electronic device 400 may place a graphical object that receives touch interaction, such as the music widget 1220, on the second plane 520 (or, surface plane) corresponding to the position of the display where an actual touch input is detected.

With reference to FIG. 12C, the gallery widget 1230 may be utilized by a user interaction corresponding to detecting a hovering input based on the stylus or detecting a user's hand gesture. The electronic device 400 may place a graphical object that enables user interaction at a position apart from the display, such as the gallery widget 1230, on the first plane 510 (or, air plane) formed outside the display.

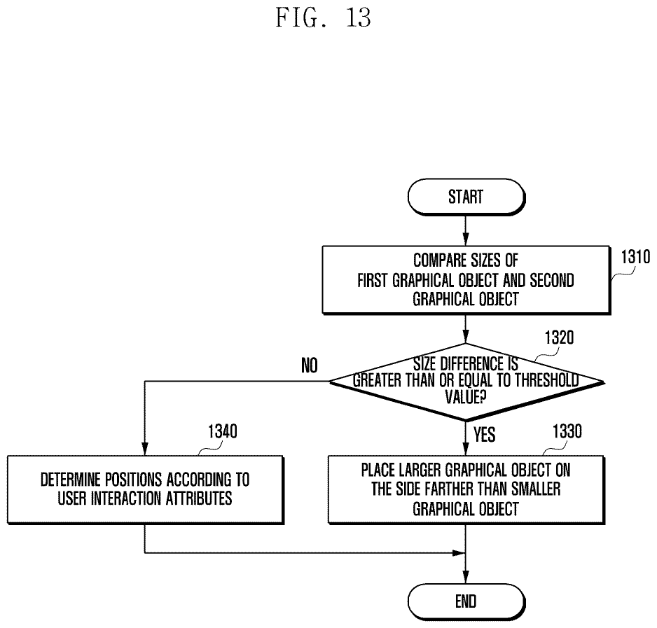

FIG. 13 is a flowchart of a method for arranging graphical objects based on the size of each graphical object and the characteristics of user interaction according to an embodiment.

The illustrated method may be performed by the processor (e.g., processor 410 in FIG. 4, comprising processing circuitry) of the electronic device (e.g., electronic device 400 in FIG. 4).

According to an embodiment, when a 3D trigger event occurs, at operation 1310, the electronic device may compare the sizes of the first graphical object and the second graphical object. For example, the electronic device may compare the sizes based on the actual information regions of the first graphical object and the second graphical object containing actual image information except for the transparent regions thereof.

According to an embodiment, at operation 1320, the electronic device may check whether the size difference between the first and second graphical objects is greater than or equal to a threshold value. Here, the threshold value may be set in advance, and may correspond to a size difference that can influence user visibility. Additionally, the threshold value may be set differently depending on the type of a graphical object (e.g., widget, pop-up window, icon).

According to an embodiment, if the size difference between the first and second graphical objects is greater than or equal to the threshold value, at operation 1330, the electronic device may place the larger graphical object on the inner side (or, in-z direction) relative to the smaller graphical object. When the difference between two graphical objects is large, the smaller graphical object may be placed in front of the larger graphical object, ensuring visibility of the two graphical objects.

According to an embodiment, if the size difference between the first and second graphical objects is less than the threshold value, at operation 1340, the electronic device may determine the positions of the first and second graphical objects based on user interaction attributes. For example, the electronic device may place a graphical object with a high user interaction frequency on the front side. When the sizes of two graphical objects are not significantly different, as there is little difference in visibility depending on which graphical object is placed on top, the position of each graphical object may be determined to facilitate user interaction. For example, a widget that displays information without including selectable items (e.g., clock widget) may be placed on the lower-side plane (e.g., third plane), and a widget that requires a lot of user touch input for selectable items (e.g., music widget) may be placed on the higher-side plane (e.g., second plane) to facilitate touch input.

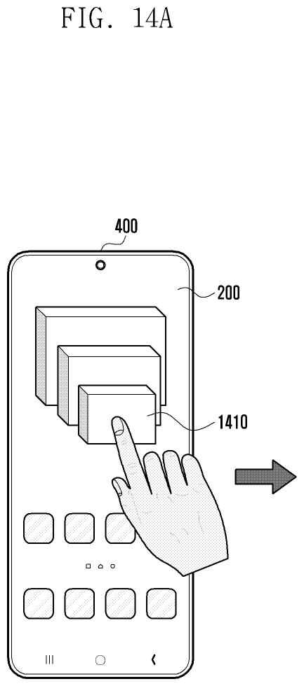

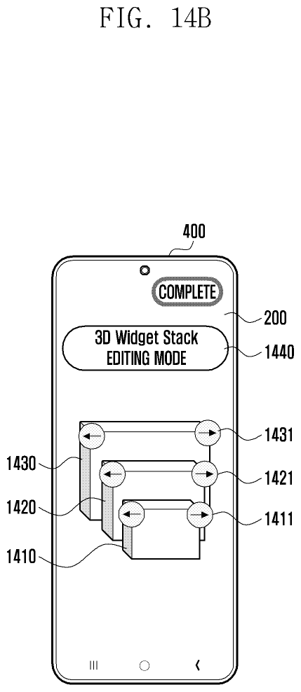

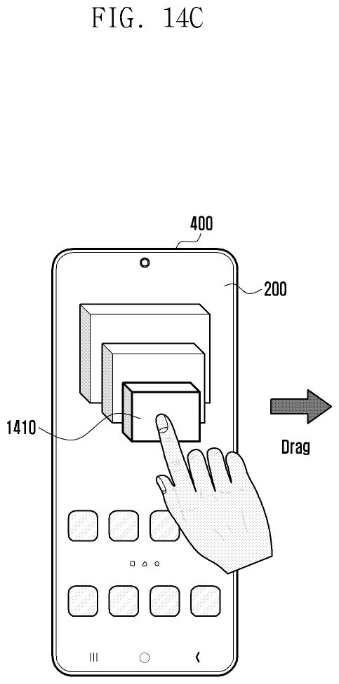

FIGS. 14A, 14B and 14C illustrate a method for editing the position of a graphical object based on user input according to an embodiment.

According to an embodiment, in 3D display mode, the electronic device 400 may change the z-axis direction position of a graphical object placed on a plane based on user input.

With reference to FIG. 14A, a first graphical object 1410, a second graphical object 1420, and a third graphical object 1430 are placed respectively on the first plane, the second plane, and the third plane, and can be recognized by the user. When the user wishes to change the front-to-back order of graphical objects arranged in space, the electronic device 400 may enter editing mode based on a preset user input. For example, the user input for entering editing mode may include a long press on a graphical object placed on the second or third plane, or a gesture of hovering on a graphical object placed on the first plane with a finger or stylus for a preset period of time.

With reference to FIG. 14B, the electronic device 400 may display a menu 1440 indicating editing mode upon entering the editing mode. The electronic device 400 may display items 1411, 1421 and 1431, which may change the z-axis positions of corresponding graphical objects, in adjacency to the corresponding graphical objects. For example, the user may touch and drag the item 1411 displayed in adjacency to the first graphical object 1410 to move it to the second plane or the third plane. Alternatively, an item that can move a graphical object to the lower plane and an item that can move a graphical object to the upper plane may be displayed in adjacency to the corresponding graphical object. When the first graphical object 1410 is moved to the second plane, the second graphical object 1420 having been placed on the second plane may be automatically moved to the first plane.

According to an embodiment, in editing mode, the electronic device 400 may change the x, y-direction position of a graphical object being parallel to the display 200 based on user input. In this case, the input for changing the x, y direction position may be different from the input for changing the position in the z-axis direction. With reference to FIG. 14C, if the user long-presses (or long-hover) the first graphical object 1410 to activate the editing mode and then continuously moves the first graphical object 1410 without releasing the touch, the electronic device 400 may change the x, y direction position of the first graphical object 1410. In this case, the electronic device 400 may not display the item 1440 indicating editing mode.

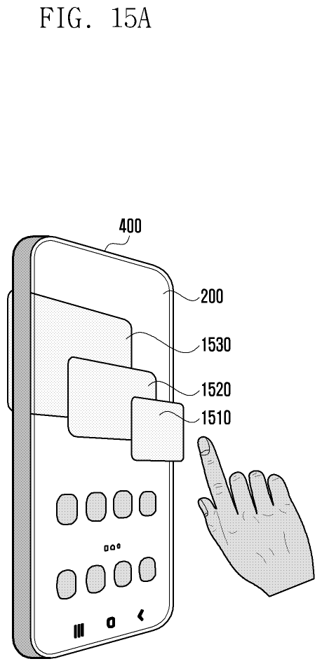

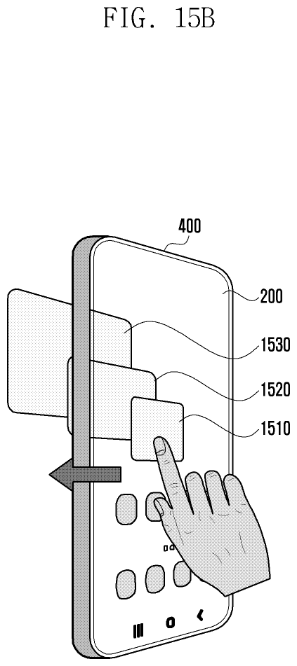

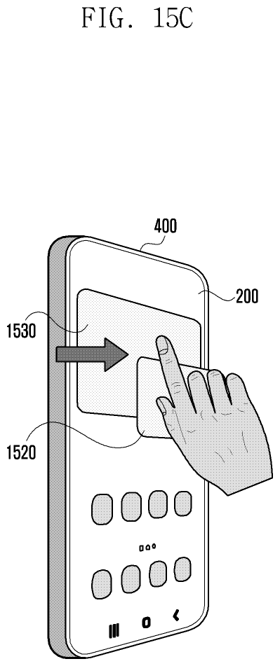

FIGS. 15A, 15B and 15C illustrate a method for editing the position of a graphical object based on user input according to an embodiment.

According to an embodiment, in 3D display mode, the electronic device 400 may change the z-axis direction positions of graphical objects placed on specific planes based on user input. In this case, when a specified user input is detected upon entering the editing mode, the electronic device 400 may enter full movement mode that can change the z-axis direction positions of all graphical objects in the 3D image.

With reference to FIG. 15A, the electronic device 400 may place a first graphical object 1510, a second graphical object 1520, and a third graphical object 1530 respectively on the first plane, the second plane, and the third plane to display them through the display 200. When a specified user input is detected while a 3D image is being displayed, the electronic device 400 may activate the full movement mode during editing mode. For example, the electronic device 400 may detect that the user selects an activation button for full movement mode on the settings menu after a 3D image is displayed on the display 200.

With reference to FIG. 15B, in full movement mode, the electronic device 400 may move the first graphical object 1510, the second graphical object 1520, and the third graphical object 1530 in a single direction on the z-axis based on a user input. For example, if the user long-presses on the display 200, the first graphical object 1510, the second graphical object 1520, and the third graphical object 1530 may all be moved in the-z direction. Alternatively, the user's drag or flick input in the −x or −y direction may be processed as an input for moving all graphical objects in the-z direction. Alternatively, if the user presses hard on the display 200 in the-z direction, the electronic device 400 may detect an input in the −z direction based on the strength of the pressure and process it as an input for moving all graphical objects in the-z direction. In this case, the first graphical object 1510 may be placed on the second plane, and the second graphical object 1520 may be placed on the third plane. The third graphical object 1530 may be placed as is on the third plane, or a fourth plane may be additionally formed further in the −z direction than the third plane and the third graphical object 1530 may be placed on the fourth plane.

According to an embodiment, even in full movement mode, if an attribute is set to indicate placement on a specific plane, the corresponding graphical object may be not moved. For example, if a specific graphical object is set to receive touch input on the display 200, this graphical object may continue to be displayed on the second plane in spite of a user input in full movement mode.

With reference to FIG. 15C, when the user long-hovers on the display 200, the first graphical object 1510, the second graphical object 1520, and the third graphical object 1530 may all be moved in the +z direction. Alternatively, a user's drag or flick input in the +x or +y direction may be processed as an input for moving all graphical objects in the +z direction. Alternatively, when the user slowly moves away in the +z direction while in contact with the display 200, the electronic device 400 may detect a change in capacitance and process it as an input for moving all graphical objects in the +z direction. In this case, the third graphical object 1530 may be placed on the second plane, and the second graphical object 1520 may be placed on the first plane. The first graphical object 1510 may be placed as is on the first plane, or a fifth plane may be additionally formed further in the +z direction than the first plane and the first graphical object 1510 may be placed on the fifth plane.

According to an embodiment, the electronic device 400 in editing mode state may display a return button, and when the return button is selected, the graphical object whose position has been changed may be restored to its original position.

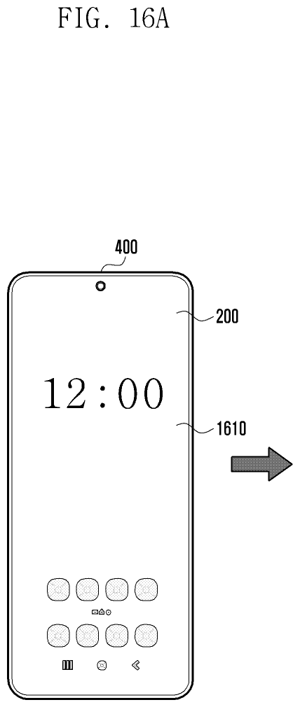

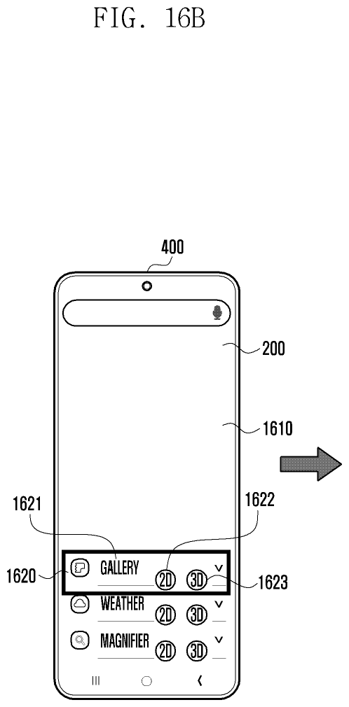

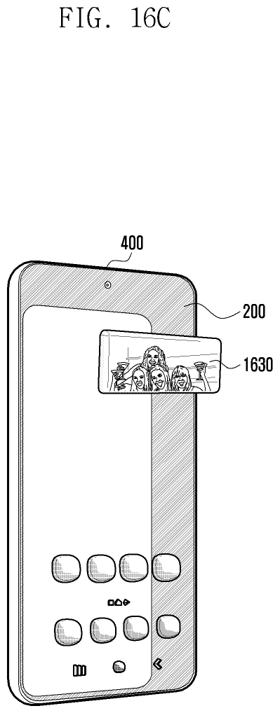

FIGS. 16A, 16B and 16C illustrate a method for creating a graphical object in 2D or 3D according to an embodiment.

According to an embodiment, when a new graphical object is generated, the electronic device 400 may compose a 2D image or 3D image including the corresponding graphical object based on a user input and display the same through the display 200.

With reference to FIG. 16A, when a user's long press input is detected while the current home screen 1610 (e.g., 2D home screen or 3D home screen) is displayed, the electronic device 400 may enter a widget addition mode.

With reference to FIG. 16B, the electronic device 400 in widget addition mode may provide a list 1620 of widgets that can be added to the current home screen. According to an embodiment, for each widget in the widget list 1620, the electronic device 400 may provide a title 1621 of the widget, and a 2D button 1622 and a 3D button 1623 for selecting whether to generate a 2D image or a 3D image.

With reference to FIG. 16C, when the user selects the 3D button 1623 of the gallery widget, the electronic device 400 may determine the z-axis direction position of the gallery widget 1630. For example, the electronic device may identify that the user interaction characteristic of the gallery widget 1630 corresponds to hovering or gesture input, and place the gallery widget 1630 on the first plane.

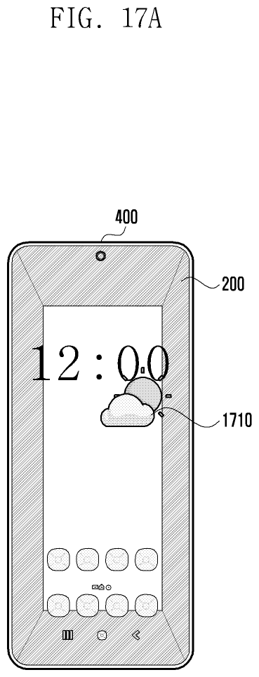

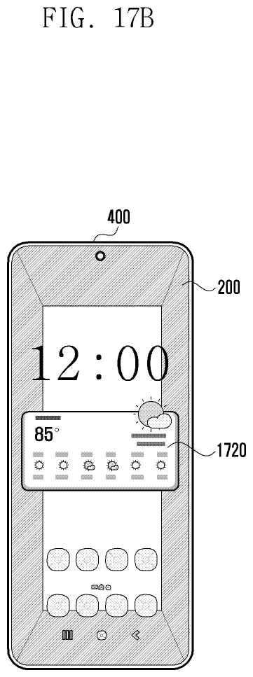

FIGS. 17A and 17B illustrate a method for setting the shape of a graphical object depending on the position where the graphical object is placed according to an embodiment.

According to an embodiment, the electronic device 400 may change the shape of a graphical object based on the z-axis position at which the graphical object is placed.

With reference to FIG. 17A, when a weather widget is placed on the first plane (or air plane), the electronic device 400 may generate and display a weather widget 1710 in the form of an icon containing brief weather information.

With reference to FIG. 17B, when a weather widget is placed on the second plane (or surface plane) or the third plane (or core plane), the electronic device 400 may generate and display a weather widget 1720 containing more detailed information. According to an embodiment, the electronic device 400 may generate and display a weather widget in the form of a 3D box.

According to an embodiment, the electronic device 400 may provide the user with a menu that allows the user to select the form in which a graphical object is displayed on a specific plane. For example, the electronic device 400 may create a graphical object by iconizing it as in FIG. 17A when reducing the size of the graphical object through the shape selection menu, and may create a graphical object by 3D boxing it as in FIG. 17B when increasing the size of the graphical object.

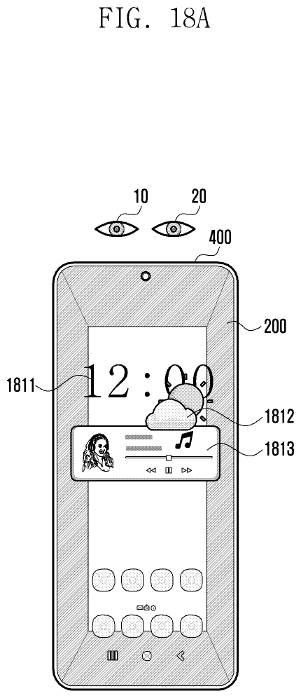

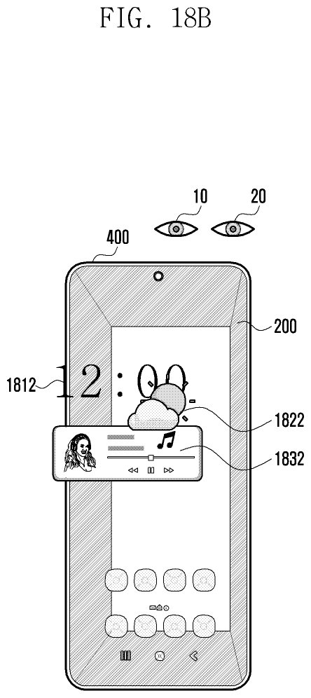

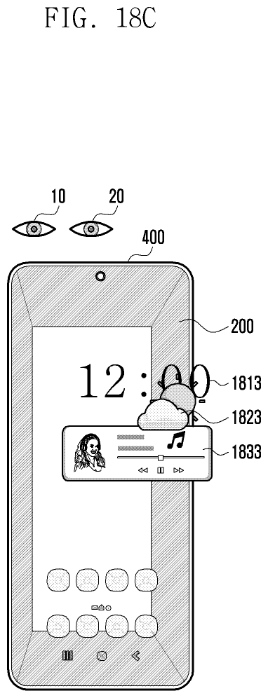

FIGS. 18A, 18B and 18C illustrate a method for transforming a graphical object based on the user's gaze direction according to an embodiment.

According to an embodiment, the electronic device 400 may track the user's gaze position based on an image obtained from the camera, and determine the position of a graphical object displayed on the 3D image based on the gaze position.

According to an embodiment, the electronic device 400 may track the user's gaze position based on images obtained from the camera (e.g., front-facing camera). For example, the electronic device 400 may analyze images obtained in real time from the camera to extract an eye region of the user and monitor the movement of the pupil to track the user's gaze position.

With reference to FIG. 18A, the electronic device 400 in 3D display mode may display a 3D image by placing a weather widget 1811, a music widget 1812, and a clock widget 1813 respectively on the first plane, the second plane, and the third plane. The electronic device 400 may track the user's gaze position by using the camera, and may align the graphical objects to the center of the display 200 if the user's gaze is located at the center of the display 200.

With reference to FIG. 18B, when the user's gaze position moves to the right (or in +x direction) from the display 200, the electronic device 400 may move the positions of individual graphical objects 1812, 1822 and 1832 to the left (or in −x direction). With reference to FIG. 18C, when the user's gaze position moves to the left (or in −x direction) from the display 200, the electronic device 400 may move the positions of individual graphical objects 1812, 1822 and 1832 to the right (or in +x direction).

In this way, the electronic device 400 may move the graphical object and background in parallel according to the user's gaze position, thereby enhancing the effect of the 3D graphical object in space.

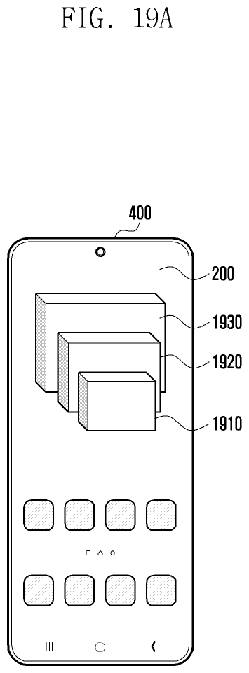

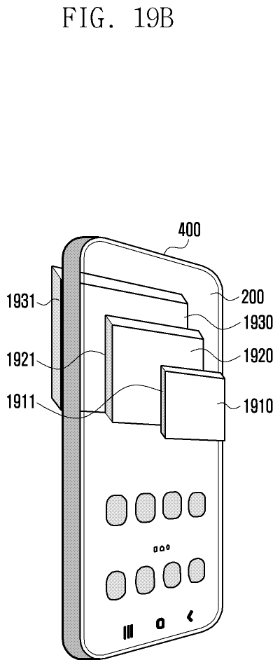

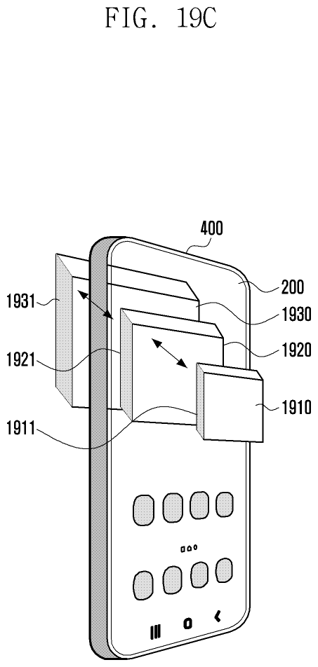

FIGS. 19A, 19B and 19C illustrate a method for transforming a graphical object based on the user's gaze direction according to an embodiment.

According to an embodiment, the electronic device 400 may detect the inclination of the electronic device 400 by using at least one sensor (e.g., acceleration sensor, gyro sensor) and modify the graphical object displayed on the 3D image based on the inclination. For example, if the user tilts the electronic device 400 sideways, the user may recognize the side surface of a graphical object, so that it is possible to provide new information through the side surface. In this case, the processor may increase the area of the side surface of a graphical object and/or increase the distance between graphical objects.

With reference to FIG. 19A, the electronic device 400 in 3D display mode may display a 3D image by placing a first graphical object 1910, a second graphical object 1920, and a third graphical object 1930 respectively on the first plane, the second plane, and the third plane. The first graphical object 1910, the second graphical object 1920, and the third graphical object 1930 may be a 3D graphical object having a three-dimensional effect.

With reference to FIG. 19B, when detecting tilting of the electronic device 400 and/or movement of the user's gaze by using the sensor, the electronic device 400 may display information specified on the side surfaces 1911, 1921 and 1931 of the graphical objects. In this case, the electronic device 400 may move each graphical object and background in parallel according to the tilt of the electronic device 400 and/or the movement of the user's gaze position, so that the information shown on the side surfaces 1911, 1921 and 1931 may be recognized from the user's gaze, and user interaction may be provided through the side surfaces 1911, 1921 and 1931.

With reference to FIG. 19C, if the tilt angle of the electronic device 400 and/or movement of the user's gaze position further increases, the electronic device 400 may further increase the spacing between the graphical objects 1910, 1920 and 1930 and/or increase the area of the side surfaces 1911, 1921 and 1931 of the graphical objects. Consequently, the user may view the information provided on the side surfaces 1911, 1921 and 1931 with the electronic device 400 further tilted, or perform user interaction through the side surfaces 1911, 1921 and 1931.

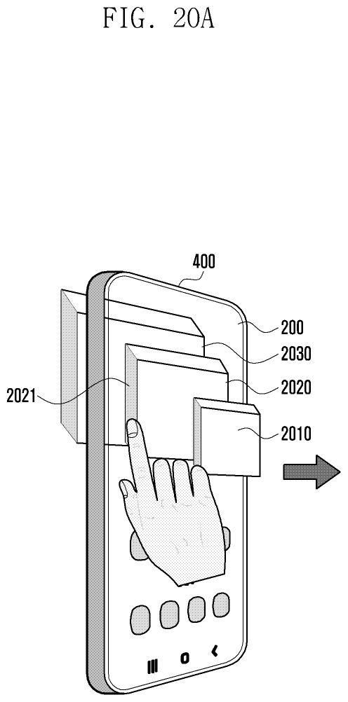

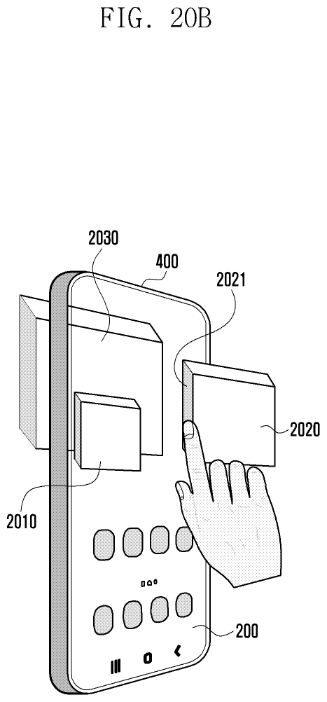

FIGS. 20A and 20B illustrate a method for changing the position of a graphical object based on user input according to an embodiment.

According to an embodiment, the electronic device 400 may change the z-axis direction position of a graphical object based on a user input on the side surface of the graphical object. The graphical object may be a 3D graphical object that includes a front surface and at least one side surface, and may include selectable items and information at at least some of the front surface and side surface.

With reference to FIGS. 20A and 20B, the electronic device 400 may display a 3D image including a first graphical object 2010, a second graphical object 2020, and a third graphical object 2030, which are a 3D graphical object. The first graphical object 2010, the second graphical object 2020, and the third graphical object 2030 may be placed respectively on the first plane, the second plane, and the third plane.

When the user touches the side surface 2021 of the second graphical object 2020 and drags it to the position of the first graphical object 2010, the second graphical object 2020 may be moved to the first plane, and the first graphical object 2010 having been placed on the first plane may be moved to the second plane.

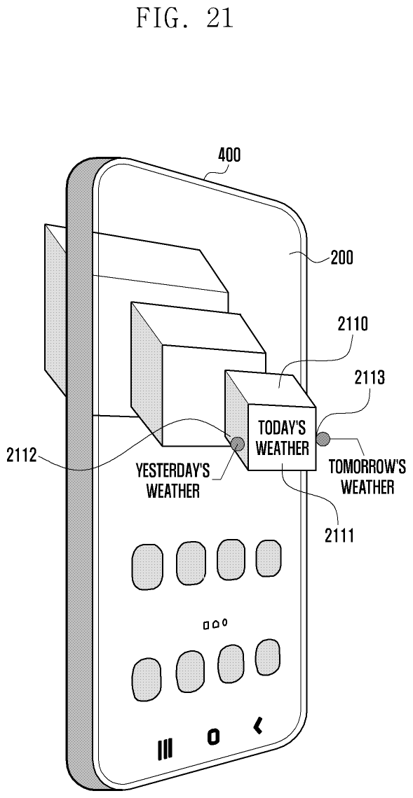

FIG. 21 illustrates information provided on faces of a 3D graphical object according to an embodiment.

According to an embodiment, graphical objects included in a 3D image may include a 2D graphical object and/or a 3D graphical object. The 2D graphical object is a flat image, and the 3D graphical object may have a three-dimensional effect in the z-axis direction. The electronic device 400 may provide different information by using the front and side surfaces of a 3D graphical object.

According to an embodiment, if the user's gaze position recognized via the camera is located at the center of the display 200, and/or if the inclination of the electronic device 400 recognized via at least one sensor (e.g., acceleration sensor, gyro sensor) is parallel to the ground, the electronic device 400 may generate a 3D image so that each graphical object is recognized at the center of the display 200. In this case, information on the left and right side surface may be not provided. When the user's gaze position moves to the left or right, and/or when the electronic device 400 is tilted to the left or right, the electronic device 400 may widen the space between graphical objects and/or increase the area of the graphical object 2110 in the z-axis to enable information provision through the side surface. The electronic device 400 may provide various information (e.g., yesterday's weather, tomorrow's weather) via the widened side surface, and the information provided through the side surface may be additional information related to the information provided through the front surface.

With reference to FIG. 21, the weather widget 2110 may be placed on the first plane of the 3D image as a 3D graphical object 2110 in the shape of a rectangular parallelepiped. The weather widget 2110 may provide today's weather information through the front surface 2111, yesterday's weather information through the left side surface 2112, and tomorrow's weather information through the right side surface 2113. When the user looks at the electronic device 400 from the front, the user may check today's weather through the front surface 2111 of the weather widget 2110; when the user looks at the electronic device 400 sideways and/or tilts the electronic device 400 to the left or right, the user may check yesterday's weather through the left side surface 2112 or check tomorrow's weather through the right side surface 2113.

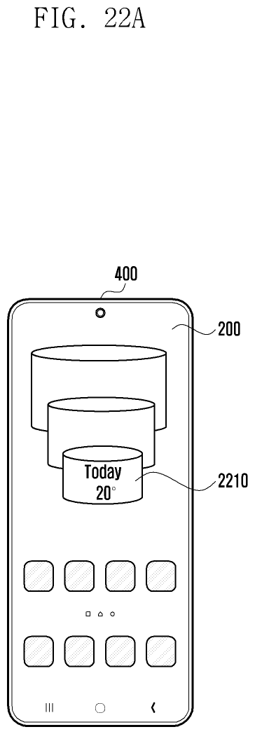

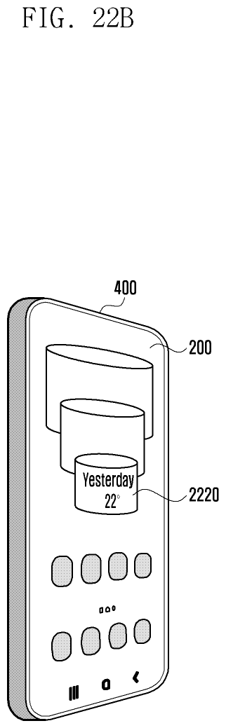

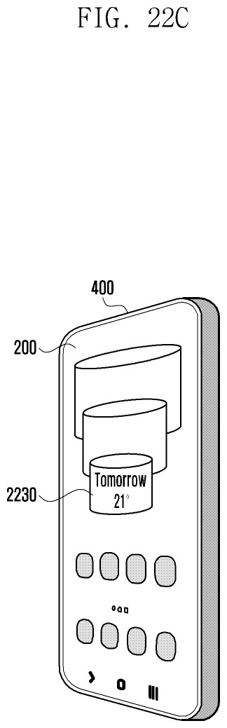

FIGS. 22A, 22B and 22C illustrate information presented by a graphical object based on the tilted angle of the electronic device according to an embodiment.

According to an embodiment, the electronic device 400 may change the information provided through a graphical object based on the user's gaze position recognized through the camera and/or the inclination of the electronic device 400 recognized through at least one sensor (e.g., acceleration sensor, gyro sensor).

With reference to FIG. 22A, when the user's gaze position is located at the center of the display 200 and/or when the inclination of the electronic device 400 is parallel to the ground, the electronic device 400 may provide today's weather information 2210 by using the weather widget placed on the first plane.

With reference to FIG. 22B, when the user's gaze position is moved to the right of the display 200 and/or when the electronic device 400 is tilted to the right, the electronic device 400 may detect this by using the camera module and/or sensor and change the information displayed at the weather widget to yesterday's weather information 2220.

With reference to FIG. 22C, when the user's gaze position is moved to the left of the display 200 and/or when the electronic device 400 is tilted to the left, the electronic device 400 may detect this by using the camera module and/or sensor and change the information displayed at the weather widget to tomorrow's weather information 2230.

As described above, the electronic device 400 may change the information provided through a graphical object based on the user's gaze position and/or inclination. Hence, information that is not visible when the user views the electronic device 400 from the front can be provided when the user tilts the electronic device 400 to either side. Depending on the design of a graphical object, new information may be visible from a new face (e.g., side surface of a rectangular parallelepiped) other than the front surface, or existing information displayed at a specific position may be changed to new information according to a change in the inclination of the electronic device 400.

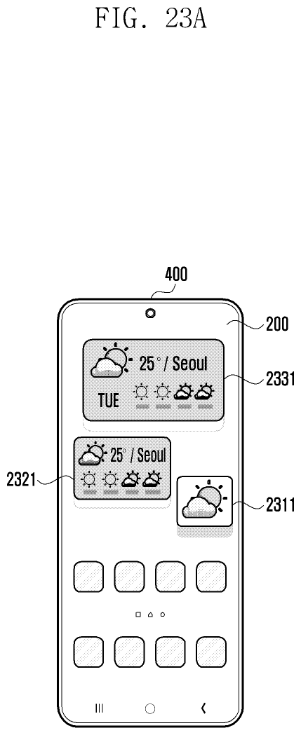

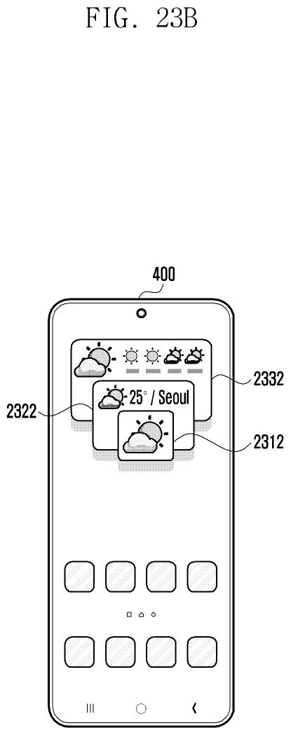

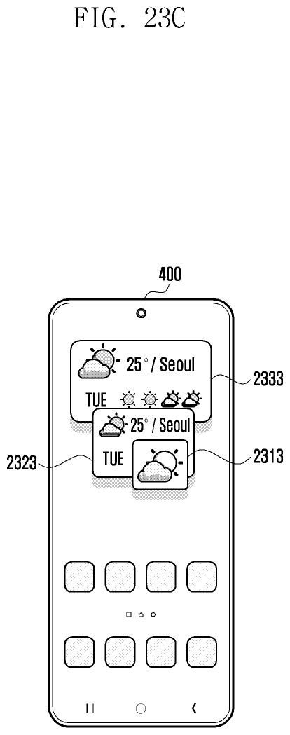

FIGS. 23A, 23B and 23C illustrate a method for changing the form of information included in graphical objects when stacking the graphical objects according to an embodiment.

According to an embodiment, when two or more graphical objects overlap each other in the z-axis direction, the electronic device 400 may change the information displayed on at least one of the overlapping graphical objects.

With reference to FIG. 23A, a first graphical object 2311, a second graphical object 2321, and a third graphical object 2331 may be placed respectively on the first plane, the second plane, and the third plane, and may not overlap each other in the z-axis direction. In this way, if graphical objects 2311, 2321 and 2331 do not overlap with each other, it is possible to provide a lot of information that can be provided through the graphical objects 2311, 2321 and 2331 of the corresponding size.

With reference to FIG. 23B, a first graphical object 2312, a second graphical object 2322, and a third graphical object 2332 may be arranged to overlap each other in response to a user input. In this case, the electronic device 400 may reduce the information displayed on the second graphical object 2322 and the third graphical object 2332 placed below in the z-axis direction and may output information through a portion that does not overlap with the first graphical object 2312 placed above.

With reference to FIG. 23C, when the size of the region overlapping with the graphical object placed above the second graphical object 2323 and the third graphical object 2333 is reduced in response to a user input, the information provided through the second graphical object 2323 and the third graphical object 2333 may be increased again.

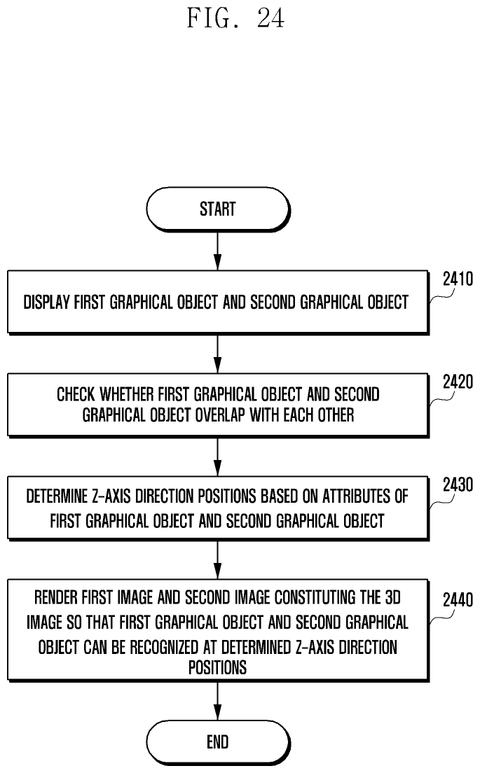

FIG. 24 is a flowchart of a method for providing a 3D image including graphical objects in the electronic device according to an embodiment.

The illustrated method may be performed by the electronic device (e.g., electronic device 400 in FIG. 4), and the description of the technical features described above will be omitted below.

According to an embodiment, at operation 2410, the electronic device may display an image including a first graphical object and a second graphical object through the display. For example, the first graphical object and the second graphical object may include, but not limited to, at least one of a widget, an icon, an application execution screen, or a pop-up window.

According to an embodiment, at operation 2420, the electronic device may check whether the first graphical object and the second graphical object of the image at least partially overlap with each other. For example, the electronic device may detect a user input on the first graphical object or second graphical object that causes the first and second graphical objects, which are spaced apart from each other, to at least partially overlap. For example, when detecting a long touch input or long hovering input to the first graphical object and/or the second graphical object, a drag and drop input of the first graphical object over the second graphical object, or a touch or hovering input to a given button, the electronic device may detect this as a 3D trigger event for displaying a 3D image.

According to an embodiment, at operation 2430, the electronic device may determine the z-axis direction positions of the first graphical object and the second graphical object based on the attributes of the first graphical object and the second graphical object. For example, a 3D image may be composed of multiple planes, which are virtual planes, and the electronic device may determine whether to place the first graphical object and the second graphical object on the first plane, the second plane, or the third plane.

According to an embodiment, the attributes of the first graphical object and the second graphical object may include the size of a graphical object and user interaction characteristics defined for a graphical object. For example, the electronic device may place the smaller graphical object among the first graphical object and the second graphical object on the side higher than the larger graphical object in the z-axis direction (or in +z direction). Alternatively, the electronic device may determine the z-axis direction position (or plane) at which the first graphical object and the second graphical object are to be placed based on the number of selectable items (or interaction components) included in the graphical object, and the frequency of user interaction and/or the type of user interaction.

According to an embodiment, at operation 2440, the electronic device may render first and second images constituting the 3D image so that the first graphical object and the second graphical object may be recognized at the determined z-axis direction positions. The electronic device includes a 3D display structure, such as a lenticular lens (e.g., lenticular lens in FIG. 2A) or a parallax barrier (e.g., parallax barrier in FIG. 2B), and may render the first and second images constituting the 3D image and output them through the display.

An electronic device according to various embodiments of the disclosure may include a display, a memory, and a processor operably connected, directly or indirectly, to the display and the memory.

According to an embodiment, the processor may render a 2D image or a 3D image that includes a first image recognizable to the user's left eye and a second image including a right-eye image recognizable to the user's right eye, and output the same through the display.

According to an embodiment, the memory may store instructions that are executable individually and/or collectively by at least one processor comprising processing circuitry and, when executed, cause the electronic device to: determine, if the 3D image to be output through the display includes a first graphical object and a second graphical object placed to overlap at least partially with the first graphical object, the positions in the z-axis direction (e.g., z-axis direction positions) being perpendicular to the display at which the first graphical object and the second graphical object are to be placed on the 3D image on the basis of the attributes of the first graphical object and the second graphical object; and render the 3D image including the first graphical object and the second graphical object, wherein the first graphical object and the second graphical object can be recognized respectively at the determined positions in the z-axis direction.

According to an embodiment, the memory may store instructions that cause the electronic device to determine, if the first graphical object and the second graphical object at least partially overlap in response to a user input to the first graphical object or the second graphical object while the first graphical object and the second graphical object are displayed on the display, the z-axis direction positions of the first graphical object and the second graphical object.

According to an embodiment, the attributes of the first graphical object and the second graphical object may include at least one of the size of a graphical object or a characteristic of a user interaction with the graphical object.

According to an embodiment, the memory may store instructions that cause the electronic device to determine the z-axis direction position of the first graphical object to be a first position if the first graphical object is larger than the second graphical object, and determine the z-axis direction position of the second graphical object to be a second position lower than the first position.

According to an embodiment, the memory may store instructions that cause the electronic device to determine the z-axis direction positions of the first graphical object and the second graphical object based on predefined user interaction characteristics for the first graphical object and the second graphical object.

According to an embodiment, the memory may store instructions that cause the electronic device to determine the z-axis direction positions of the first graphical object and the second graphical object based on selectable items included in the first graphical object and the second graphical object.

According to an embodiment, the memory may store instructions that cause the electronic device to determine the z-axis direction positions of the first graphical object and the second graphical object based on the frequency of user interaction with the first graphical object and the second graphical object.

According to an embodiment, the memory may store instructions that cause the electronic device to determine the z-axis direction positions of the first graphical object and the second graphical object based on the sizes of the first graphical object and the second graphical object if the difference in size between the first graphical object and the second graphical object is greater than or equal to a reference value, and determine the z-axis direction positions of the first graphical object and the second graphical object based on the characteristics of user interaction with the first graphical object and the second graphical object if the difference in size between the first graphical object and the second graphical object is less than the reference value.

According to an embodiment, the memory may store instructions that cause the electronic device to change the information included in the first graphical object and the second graphical object based on the z-axis direction positions of the first graphical object and the second graphical object.

According to an embodiment, the memory may store instructions that cause the electronic device to place the first graphical object on one of plural planes formed at positions spaced apart from each other in the z-axis direction from the display, and place the second graphical object on another plane of the plural planes.

According to an embodiment, the plural planes may include a first plane formed outside the electronic device in the z-axis direction from the display, a second plane formed at the position of the display, and a third plane formed inside the electronic device in the z-axis direction from the display.

According to an embodiment, the memory may store instructions that cause the electronic device to place the first graphical object on the second plane if the first graphical object includes a selectable item that can be selected using a touch input, place the first graphical object on the first plane if the first graphical object includes a selectable item that can be selected using a hovering input, and place the first graphical object on the third plane if the first graphical object does not include a selectable item.

According to an embodiment, the memory may store instructions that cause the electronic device to change the z-axis direction position of at least one of the first graphical object or the second graphical object based on a user input detected while the editing mode is activated.

According to an embodiment, the first graphical object and the second graphical object may include at least one of a widget, an icon, an application execution screen, or a pop-up window.

According to an embodiment, the first graphical object and the second graphical object may be a 3D graphical object.

According to an embodiment, the display may include one of a lenticular lens and a parallax barrier for implementing a 3D effect through the first image and the second image.

A method for an electronic device to provide a 3D image according to various embodiments of the disclosure may include: determining, if the 3D image to be output through the display of the electronic device includes a first graphical object and a second graphical object placed to overlap at least partially with the first graphical object, the positions in the z-axis direction being perpendicular to the display at which the first graphical object and the second graphical object are to be placed on the 3D image on the basis of the attributes of the first graphical object and the second graphical object; and rendering the 3D image including the first graphical object and the second graphical object, wherein the first graphical object and the second graphical object can be recognized respectively at the determined positions in z-axis direction (e.g., z-axis direction positions).

According to an embodiment, determining the z-axis direction positions may include: comparing respective sizes of the first graphical object and the second graphical object; and based on the first graphical object being larger than the second graphical object, determining the z-axis direction position of the first graphical object to be a first position and determining the z-axis direction position of the second graphical object to be a second position lower than the first position.

According to an embodiment, determining the z-axis direction positions may include determining the z-axis direction positions of the first graphical object and the second graphical object based on predefined user interaction characteristics for the first graphical object and the second graphical object.

According to an embodiment, determining the z-axis direction positions may include determining one of plural planes formed at positions spaced apart from each other in the z-axis direction from the display to be the position of the first graphical object and the second graphical object.

According to an embodiment, determining the z-axis direction positions may include at least one of placing the first graphical object on a second plane formed at the position of the display if the first graphical object includes a selectable item that can be selected using a touch input, placing the first graphical object on a first plane formed outside the electronic device in the z-axis direction from the display if the first graphical object includes a selectable item that can be selected using a hovering input, or placing the first graphical object on a third plane formed inside the electronic device in the z-axis direction from the display if the first graphical object does not include a selectable item.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element(s). Thus, “connected” as used herein covers both direct and indirect connections.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120, comprising processing circuitry) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a display;
a memory; and
at least one processor, comprising processing circuitry, operably connected to the display and the memory,
wherein the memory stores instructions that are executable by the at least one processor individually and/or collectively, and when executed, cause the electronic device to:
render a 2D image and/or a 3D image that includes a first image recognizable to a user's left eye and a second image including a right-eye image recognizable to a user's right eye, and output the same via the display;
determine, in a case that the 3D image to be output via the display includes a first graphical object and a second graphical object placed to overlap at least partially with the first graphical object, z-axis direction positions indicating positions in a z-axis direction perpendicular to the display at which the first graphical object and the second graphical object are to be placed on the 3D image based on attributes of the first graphical object and the second graphical object; and
render the 3D image, including the first graphical object and the second graphical object, wherein the first graphical object and the second graphical object are recognizable respectively at the determined z-axis direction positions.

2. The electronic device of claim 1, wherein the memory stores instructions that cause the electronic device to determine, in a case that the first graphical object and the second graphical object at least partially overlap in response to a user input to the first graphical object and/or the second graphical object while the first graphical object and the second graphical object are displayed on the display, the z-axis direction positions of the first graphical object and the second graphical object.

3. The electronic device of claim 1, wherein the attributes of the first graphical object and the second graphical object include at least one of a size of a graphical object or a characteristic of a user interaction with the graphical object.

4. The electronic device of claim 3, wherein the memory stores instructions that cause the electronic device to determine the z-axis direction position of the first graphical object to be a first position in case that the first graphical object is larger than the second graphical object, and determine the z-axis direction position of the second graphical object to be a second position lower than the first position.

5. The electronic device of claim 3, wherein the memory stores instructions that cause the electronic device to determine the z-axis direction positions of the first graphical object and the second graphical object based on at least one of: selectable items included in the first graphical object and the second graphical object or frequencies of user interaction with the first graphical object and the second graphical object.

6. The electronic device of claim 1, wherein the memory stores instructions that cause the electronic device to:
determine the z-axis direction positions of the first graphical object and the second graphical object based on sizes of the first graphical object and the second graphical object in a case that difference in size between the first graphical object and the second graphical object is greater than or equal to a reference value; and
determine the z-axis direction positions of the first graphical object and the second graphical object based on characteristics of user interaction with the first graphical object and the second graphical object in a case that difference in size between the first graphical object and the second graphical object is less than the reference value.

7. The electronic device of claim 1, wherein the memory stores instructions that cause the electronic device to change information included in the first graphical object and the second graphical object based on the z-axis direction positions of the first graphical object and the second graphical object.

8. The electronic device of claim 1, wherein the memory stores instructions that cause the electronic device to place the first graphical object on one of plural planes formed at positions spaced apart from each other in the z-axis direction from the display, and place the second graphical object on another plane of the plural planes.

9. The electronic device of claim 8, wherein the plural planes include a first plane formed outside the electronic device in the z-axis direction from the display, a second plane formed at a position of the display, and a third plane formed inside the electronic device in the z-axis direction from the display.

10. The electronic device of claim 9, wherein the memory store instructions that cause the electronic device to:
place the first graphical object on the second plane in a case that the first graphical object includes a selectable item that is selectable via a touch input;
place the first graphical object on the first plane in a case that the first graphical object includes a selectable item that is selectable via a hovering input; and
place the first graphical object on the third plane in a case that the first graphical object does not include a selectable item.

11. The electronic device of claim 1, wherein the display includes a lenticular lens and/or a parallax barrier for implementing a 3D effect via the first image and the second image.

12. A method for an electronic device to provide a 3D image, the method comprising:
determining, in a case that the 3D image to be output via a display of the electronic device includes a first graphical object and a second graphical object placed to overlap at least partially with the first graphical object, z-axis direction positions indicating positions in a z-axis direction substantially perpendicular to the display at which the first graphical object and the second graphical object are to be placed on the 3D image based on attribute(s) of the first graphical object and the second graphical object; and
rendering the 3D image including the first graphical object and the second graphical object wherein the first graphical object and the second graphical object are recognizable respectively at the determined z-axis direction positions.

13. The method of claim 12, wherein determining z-axis direction positions comprises:
comparing respective sizes of the first graphical object and the second graphical object; and
based on the first graphical object being larger than the second graphical object determining the z-axis direction position of the first graphical object to be a first position, and determining the z-axis direction position of the second graphical object to be a second position lower than the first position.

14. The method of claim 12, wherein determining z-axis direction positions comprises determining the z-axis direction positions of the first graphical object and the second graphical object based on predefined user interaction characteristics for the first graphical object and the second graphical object.

15. The method of claim 12, wherein determining z-axis direction positions comprises determining one of plural planes formed at positions spaced apart from each other in the z-axis direction from the display to be the position of the first graphical object and the second graphical object.
